(19) United States
(12) Patent Application Publication
(10) Pub. No.: US 2026/0031745 A1
(43) Pub. Date: Jan. 29, 2026

(54) ARM ARRAY FOR DEVICES

(71) Applicant: Taiwan Semiconductor Manufacturing Company, LTD., Hsinchu (TW)

(72) Inventor: Yu-Hsun Li, Yunlin County (TW)

(21) Appl. No.: 18/786,154

(22) Filed: Jul. 26, 2024

(51) Int. Cl. H02N 1/00; G03B 30/00

(52) U.S. Cl. CPC H02N 1/008; G03B 30/00

(57) ABSTRACT

A micro-electromechanical system (MEMS) structure is useful as an actuator for optical image stabilization. The MEMS actuator includes one or more micromechanical arm arrays. Each arm array includes a first array of spaced-apart fingers and a second array of spaced-apart fingers, the fingers being formed from an electrically conductive material. The fingers of the first array are offset from the fingers of the second array. The distal ends of the first array of fingers and the distal ends of the second array of fingers are separated from each other by a lateral trench. Micro-springs connect the distal ends of fingers in the first array to the distal ends of fingers in the second array. A metal cap may be present above one or both arrays of fingers. Rivets may extend from the metal cap into the fingers themselves. The resulting structure has increased stability and strength.

### BACKGROUND

Micro-electromechanical systems (MEMS) is a technology that employs miniature mechanical and electro-mechanical elements (e.g., devices or structures) on a wafer substrate. Devices or structures that can be used in MEMS include sensors, actuators, and other structures. MEMS devices may be used in a wide range of applications, including, for example and without limitation, optical/imaging devices, and the like.

MEMS structures can be made using photolithographic patterning processes that use ultraviolet light to transfer a desired mask pattern to a photoresist on a semiconductor wafer. Etching processes may then be used to transfer to the pattern to a layer below the photoresist. This process is repeated multiple times with different patterns to build different layers on the wafer substrate and make a useful device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a Y-axis side cross-sectional view of a micromechanical arm array, in accordance with some embodiments of the present disclosure.

FIG. 2A is a plan view of the micromechanical arm array showing two arrays of fingers, with micro-springs connecting adjacent offset fingers between the two arrays, and micro-springs connecting adjacent fingers of the same array, and showing a metal cap/webbing between some fingers of the same array. Each finger may have from 2 to 4 micro-springs.

FIG. 2B is a plan view of the micromechanical arm array of FIG. 2A, showing additional aspects.

FIG. 3A is an X-axis side cross-sectional view of two fingers in different arrays, showing additional aspects.

FIG. 3B is a Y-axis side cross-sectional view of two adjacent fingers in the same array, showing additional aspects. Here, the micro-spring is in a “high” position.

FIG. 3C is a Y-axis side cross-sectional view of another embodiment of two adjacent fingers in the same array, showing additional aspects. Here, the micro-spring is in a “medium” position.

FIG. 3D is a Y-axis side cross-sectional view of a third embodiment of two adjacent fingers in the same array, showing additional aspects. Here, the micro-spring is in a “low” position.

FIG. 4A is a Y-axis side cross-sectional view of an alternative embodiment of two adjacent fingers in the same array. Here, the metal cap has “rivets” into the fingers.

FIG. 4B is a plan view of the micromechanical arm array with the fingers of FIG. 4A, showing a first embodiment where the two arrays of fingers are separated and offset, with micro-springs connecting adjacent offset fingers between the two arrays.

FIG. 4C is a plan view of the micromechanical arm array with the fingers of FIG. 4A, showing a second embodiment where the distal ends of the two arrays of fingers are interposed between each other. Micro-springs may be present as well.

FIGS. 5A-5C together are a flow chart illustrating a first method for making a micromechanical arm array for a MEMS actuator, in accordance with some embodiments.

FIG. 6 is a Y-axis cross-sectional view of a package used for making the micromechanical arm array.

FIG. 7A is a plan view of the package after a first etching step. FIG. 7B is a Y-axis cross-sectional view of the package through line B-B of FIG. 7A. FIG. 7C is a Y-axis cross-sectional view of the package through line C-C of FIG. 7A.

FIG. 8A is a plan view of the package after a second etching step. FIG. 8B is a Y-axis cross-sectional view of the package through line B-B of FIG. 8A, after a second etching step. FIG. 8C is a Y-axis cross-sectional view of the package through line C-C of FIG. 8A.

FIG. 9A is a Y-axis cross-sectional view of the package through line B-B of FIG. 8A, after formation of a first dielectric layer. FIG. 9B is a Y-axis cross-sectional view of the package through line C-C of FIG. 8A.

FIG. 10A is a Y-axis cross-sectional view of the package through line B-B of FIG. 8A, after metal deposition. FIG. 10B is a Y-axis cross-sectional view of the package through line C-C of FIG. 8A.

FIG. 11A is a plan view of the package after etching to form metal layers on pillars. FIG. 11B is a Y-axis cross-sectional view of the package through line B-B of FIG. 11A. FIG. 11C is a Y-axis cross-sectional view of the package through line C-C of FIG. 11A.

FIG. 12A is a Y-axis cross-sectional view of the package through line C-C of FIG. 11A, after silicon deposition into the lateral trench and extension of the first dielectric layer. FIG. 12B is a Y-axis cross-sectional view of the package through line B-B of FIG. 11A, and shows optional etching to form sacrificial spacers on the pillars. FIG. 12C is a Y-axis cross-sectional view of the package through line B-B of FIG. 11A, and shows optional addition to the first dielectric layer on exposed surfaces.

FIG. 13 is a Y-axis cross-sectional view of the package through line B-B of FIG. 11A, after deposition of electrically conductive material to form a first array of fingers and a second array of fingers.

FIG. 14 is a Y-axis cross-sectional view of the package through line B-B of FIG. 11A, after CMP of the electrically conductive material.

FIG. 15 is a Y-axis cross-sectional view of the package through line B-B of FIG. 11A, after further addition to the first dielectric layer over the two arrays of fingers.

FIG. 16A is a plan view of the package after partial etching of the first dielectric layer to expose portions of the top wafer. FIG. 16B is a Y-axis cross-sectional view of the package through line B-B of FIG. 16A.

FIG. 17 is a Y-axis cross-sectional view of the package through line B-B of FIG. 16A, after deposition of a first etch stop layer over the top wafer.

FIG. 18 is a Y-axis cross-sectional view of the package through line B-B of FIG. 16A, after formation of a second dielectric layer.

FIG. 19A is a plan view of the package after partial etching of the second dielectric layer. FIG. 19B is a Y-axis cross-sectional view of the package through line B-B of FIG. 19A.

FIG. 20 is a Y-axis cross-sectional view of the package through line B-B of FIG. 19A, after deposition of a second etch stop layer over the top wafer.

FIG. 21A is a plan view of the package after etching of the etch stop layers to expose various portions of the top wafer. FIG. 21B is a Y-axis cross-sectional view of the package through line B-B of FIG. 21A.

FIG. 22A is a plan view of the package after optional etching to form openings in the fingers, for later formation of rivets. FIG. 22B is a Y-axis cross-sectional view of the package through line B-B of FIG. 22A.

FIG. 23A is a Y-axis cross-sectional view of the package through line B-B of FIG. 22A, after deposition of metal. FIG. 23B is a Y-axis cross-sectional view of the package after deposition of metal if the optional etching to form openings in the fingers is performed, showing the formation of rivets.

FIG. 24A is a plan view of the package after optional etching to form openings in the fingers, after etching to form a metal cap over each array of fingers. FIG. 24B is a Y-axis cross-sectional view of the package through line B-B of FIG. 24A.

FIG. 25A is a plan view of the package after optional etching to form openings in the fingers, after formation of a passivation layer. FIG. 25B is a Y-axis cross-sectional view of the package through line B-B of FIG. 25A.

FIG. 26 is a Y-axis cross-sectional view of the package through line B-B of FIG. 25A, after etching through the etch stop layers and partial silicon etching of the top wafer.

FIG. 27A is a plan of the package after complete silicon etching of the top wafer to form a cavity below the micromechanical arm array. FIG. 27B is a Y-axis cross-sectional view through line B-B of FIG. 27A. FIG. 27C is a Y-axis cross-sectional view through line C-C of FIG. 27A.

FIG. 28A is a plan view of the package after annealing and the bottom wafer is removed, leaving the top wafer. FIG. 28B is a Y-axis cross-sectional view through line B-B of FIG. 28A.

FIG. 29 is a flow chart illustrating a second method for making a micromechanical arm array for a MEMS actuator, in accordance with some embodiments.

FIG. 30 is a flow chart illustrating a third method for making a micromechanical arm array for a MEMS actuator, in accordance with some embodiments.

FIG. 31 is a plan view of a MEMS actuator, in accordance with some embodiments.

FIG. 32 is a flow chart illustrating a method for stabilizing an optical image against external movement, in accordance with some embodiments.

FIG. 33A is a side cross-sectional view of an optical image capture device in a first position. FIG. 33B is a side cross-sectional view of the device in a second position.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

The present disclosure relates to structures which are made up of different layers. When the terms “on” or “upon” are used with reference to two different layers (including the substrate), they indicate merely that one layer is on or upon the other layer. These terms do not require the two layers to directly contact each other, and permit other layers to be between the two layers. For example all layers of the structure can be considered to be “on” the substrate, even though they do not all directly contact the substrate. The term “directly” may be used to indicate two layers directly contact each other without any layers in between them. In addition, when referring to performing process steps to the substrate or upon the substrate, this should be construed as performing such steps to whatever layers may be present on the substrate as well, depending on the context.

The present disclosure refers to “arrays” or “sets” of components. An array or set contains at least one component, and cannot contain zero components. These terms should not be interpreted as requiring a minimum of two components.

The present disclosure relates to arm arrays that may be used in various devices, and are especially suited for use in a micro-electromechanical system (MEMS) actuator. The MEMS actuator can convert electrical signals into mechanical signals, and is usually electrically connected to other integrated circuits (ICs) to form a system. Such actuators are commonly used in optical image capture devices, such as cameras which can be present as standalone handheld cameras or as part of devices like cellphones. However, the micromechanical arm arrays can be broken, for example due to impacts/shocks like drops from a large height.

In the present disclosure, new arm arrays are disclosed that have improved stability and strength. The arm array includes two arrays of fingers, each array of fingers extending from an arm. In some embodiments, the fingers of the two arrays extend towards each other, are offset from each other, and are spaced apart from each other by a lateral trench. Micro-springs are present that extend from each finger of one array across the lateral trench to one or more fingers of the other array. Micro-springs may also be present between adjacent fingers in the same array. In some additional embodiments, a metal cap is present above an array of fingers. A metal cap above the array of fingers includes rivets that extend into the fingers. These structures have improved spring lifetime, stability, and strength.

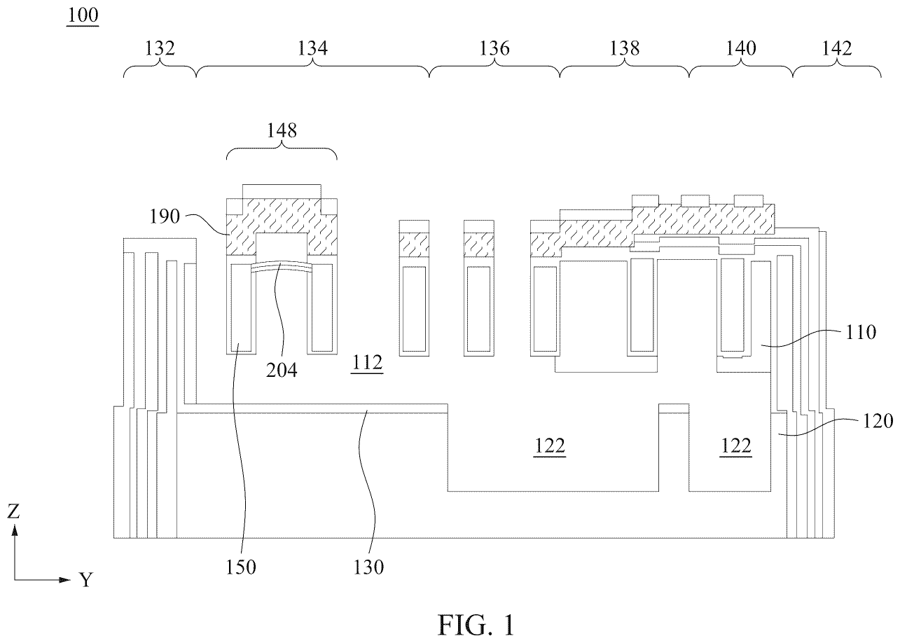

FIG. 1 is a side cross-sectional view of a first example embodiment of a package 100 that includes an arm array 148, in accordance with some embodiments of the present disclosure.

The package 100 includes a top wafer 110 (also known as a device wafer) and a bottom wafer 120 (also known as a handle wafer), which are bonded together through a bonding layer 130. This package is also known as a silicon-on-insulator (SOI) substrate.

Continuing, the micromechanical arm array 148 is present in the top wafer 110. The top wafer 110 has multiple sections in the horizontal direction, which are labeled here as an anchor arm section 132, a driving comb section 134, a hinge section 136, an inner frame section 138, a spring section 140, and an outer frame section 142. The micromechanical arm array 148 is located in the driving comb section 134. These various sections together make up a quadrant of a MEMS actuator (as will be discussed later herein).

The anchor arm section 132 provides structural integrity and aids in supporting the driving comb section. The hinge section 136 allows for pivotal movement, or allows for the controlled rotation of other components relative to the driving comb section. The inner frame section 138 provides structural support and stability. The spring section 140 provides some elasticity to maintain the desired positioning and movement of the components, and also provides a restoring force to bring the components back to their original position after actuation. The outer frame section 142 generally provides structural integrity, protecting the internal components from external and environmental forces.

A cavity 112 is present within the top wafer 110. The micromechanical arm array 148 is disposed within the cavity and can move freely within the cavity. The cavity also extends continuously below the hinge section 136, the inner frame section 138, and the spring section 140. Two smaller cavities 122 are also present within the bottom wafer 120, which are generally located below the hinge section 136, the inner frame section 138, and the spring section 140. The cavity 112 in the top wafer 110 is connected to the two smaller cavities 122 in the bottom wafer 120.

The micromechanical arm array contains two separate arrays of fingers, an array of first electrically conductive fingers 150 and an array of second electrically conductive fingers 170 (not visible here), which may also be referred to herein as a first array of fingers and a second array of fingers. It is noted that there may be more than one array of first fingers, and more than one array of second fingers. A metal cap 196 is present above each array of fingers 150, 170. In addition, lateral micro-springs 204 are present between adjacent fingers 150 within a given array of fingers.

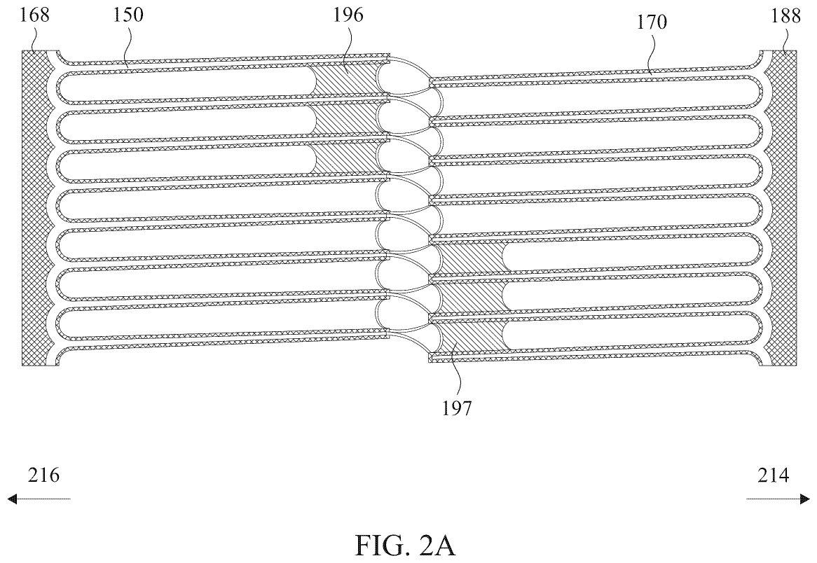

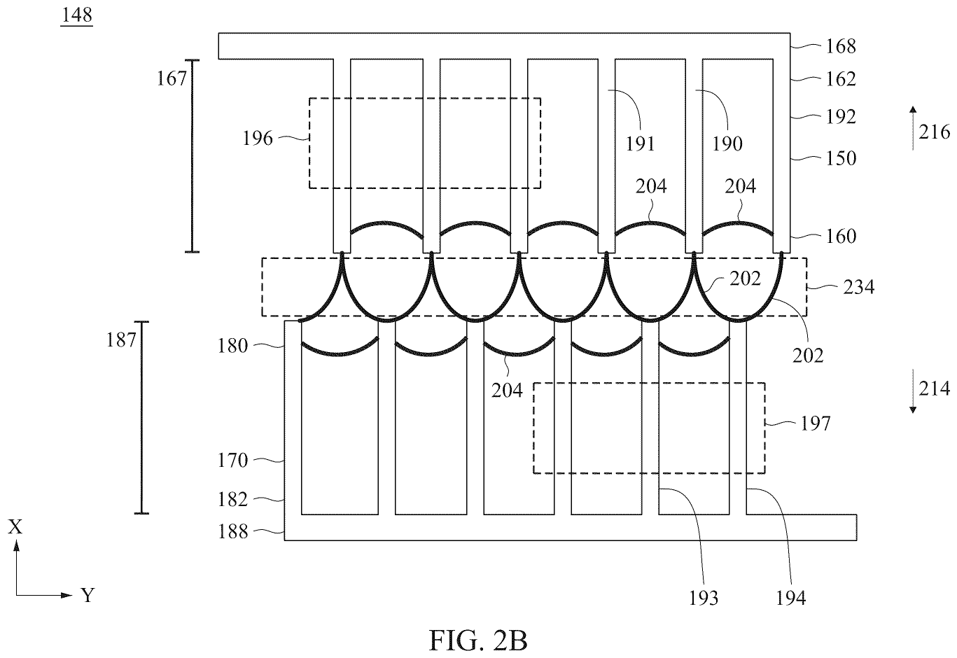

FIG. 2A is a plan view of the micromechanical arm array of FIG. 1. Again, this is an extremely simplified illustration provided only for purposes of description, and is not fully representative of the complete micromechanical arm array 148.

Here, the array of first electrically conductive fingers 150 and the array of second electrically conductive fingers 170 are better seen. The first fingers 150 extend in a first direction 214 and are joined to a first arm 168. Put another way, the first fingers 150 extend from the first arm. The first arm is also made from the same electrically conductive material as the first fingers. The second fingers 170 extend in a second direction 216 opposite the first direction and are joined to a second arm 188. Put another way, the second fingers 170 extend from the second arm. The second arm is also made from the same electrically conductive material as the second fingers. The fingers 150, 170, extend in a first horizontal direction (i.e. X-axis, or longitudinal direction). The two arms 168, 188 extend in a second horizontal direction (i.e. Y-axis, or lateral direction). Although not illustrated here, the other ends of the two arms are connected to the anchor arm section 132 and the outer frame section 142. Also visible here is a metal cap 196 over some of the first fingers 150. A metal cap 197 is also present over some of the second fingers 170.

FIG. 2B is a schematic magnified plan view of the micromechanical arm array of FIG. 2A, showing additional aspects. Initially, the first fingers 150 and the second fingers 170 are shown. The proximal ends 162 of the first fingers are joined to the first arm 168, and the distal ends 160 extend away from the first arm in a first direction 214. Similarly, the proximal ends 182 of the second fingers are joined to the second arm 188, and the distal ends 180 extend away from the second arm in the second direction 216. The first fingers 150 may be described as extending from the first arm 168 towards the second fingers 170, and vice versa. In some embodiments, the fingers 150, 170 may independently have a length 167, 187 of about 1 millimeter (mm) to about 3 mm, although other values and ranges are within the scope of this disclosure.

The first fingers 150 are spaced apart laterally from each other. Similarly, the second fingers 170 are spaced apart laterally from each other. The first fingers 150 are laterally offset from the second fingers 170. In this plan view, the offset is reflected in fingers 150, 170 not being aligned with each other in the first and second directions 214, 216. For example, if the first fingers 150 and 170 were moved in the first or second direction towards each other, their distal ends would not contact each other, but instead would become interposed or interlaced with each other.

A given finger within a given array may have one or two adjacent fingers within that array, depending on the location of the given finger. For example, first finger 190 has adjacent first finger 191 on one side, and adjacent first finger 192 on the other side. A given finger within a given array also may have one or two adjacent fingers on the other array. Those adjacent fingers on the other array are the closest fingers to the given finger. For example, first finger 190 has adjacent second finger 193 on one side, and adjacent second finger 194 on the other side. The distal ends 160 of the first fingers 150 do not overlap with the distal ends 180 of the second fingers 170, either horizontally or vertically. A lateral trench 234 lies between the two arrays of fingers 150, 170.

For a given finger in one array, longitudinal micro-springs 202 connect that finger to the adjacent fingers in the other array. For example, first finger 190 is connected via longitudinal micro-springs 202 to adjacent second fingers 193, 194. The longitudinal micro-springs are generally connected between the distal ends of the first fingers and the second fingers.

Lateral micro-springs 204 connect the ends of adjacent fingers within a given array of fingers. For example, first finger 190 is connected via lateral micro-springs 204 to adjacent first fingers 191, 192. The lateral micro-springs are also generally connected to the distal ends of the first fingers and the second fingers. The combination of micro-springs 202, 204 results in a structure that looks very similar to netting. It is noted the micro-springs 202, 204 are illustrated here with a curved structure only for purposes of distinguishing them from other features. In a physical device, they may be in the form of relatively straight lines.

Separate metal caps 196, 197 are also present over each array of fingers. It is noted that the metal caps are not required to cover all first fingers or second fingers. In addition, the metal caps do not need to be aligned with each other, although they can be.

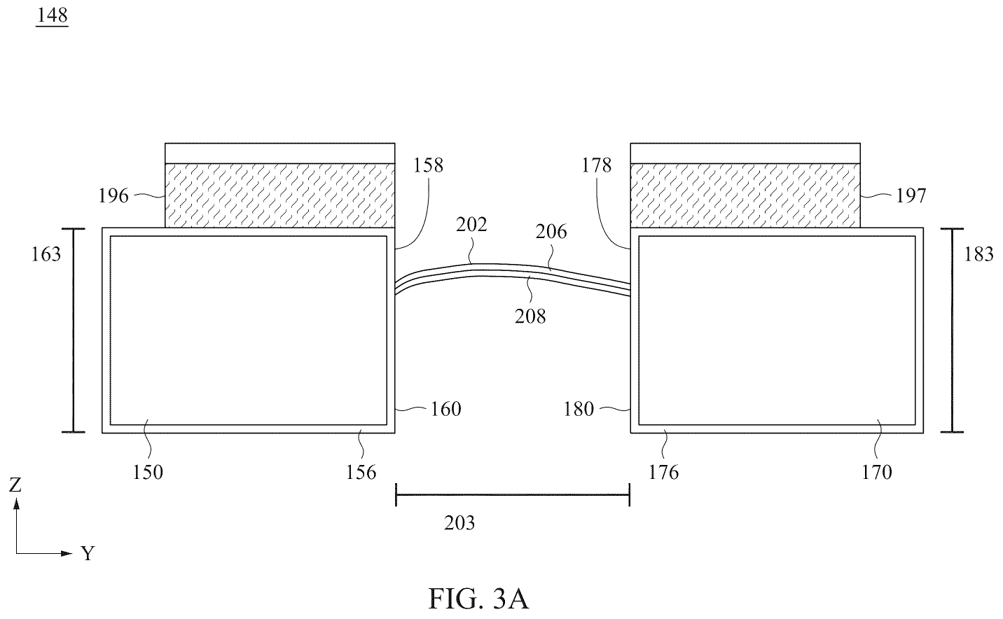

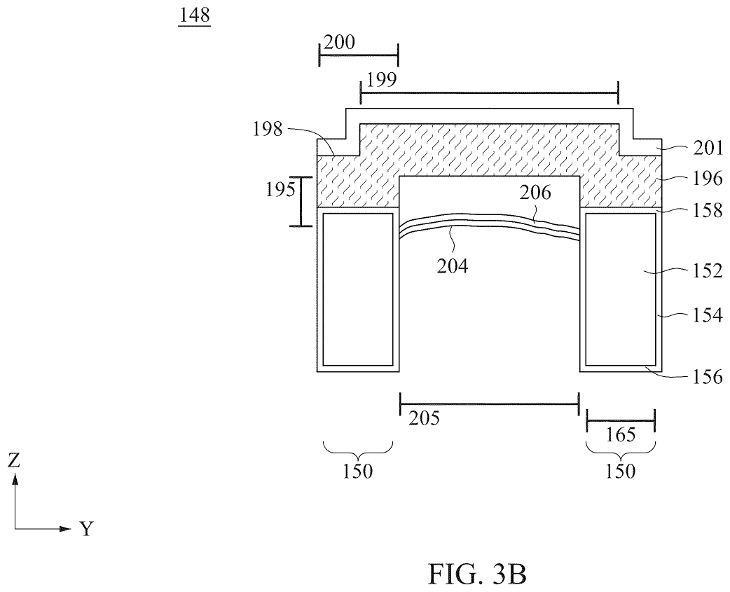

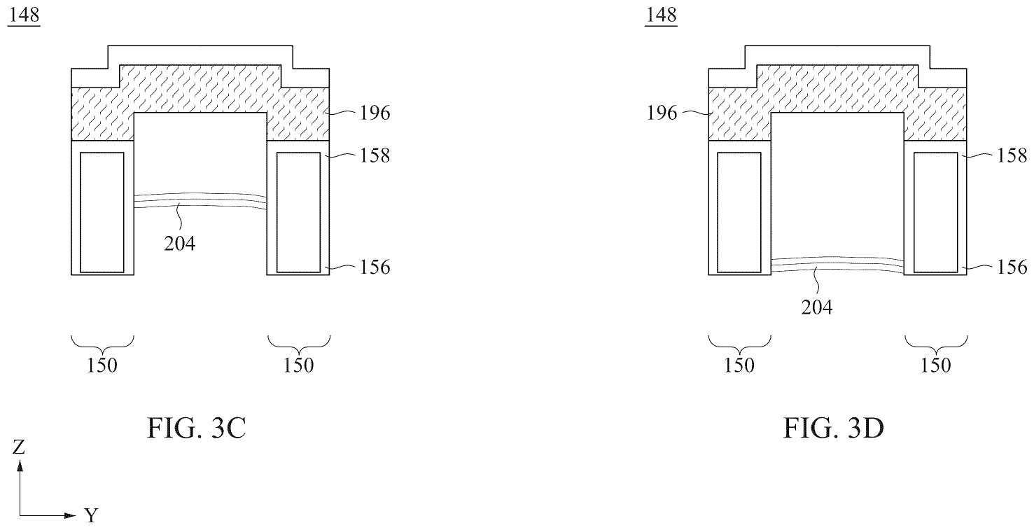

FIG. 3A is a magnified X-axis side cross-sectional view of a first finger 150 and a second finger 170, showing additional aspects. As illustrated here, the distal ends 160, 180 of the first finger 150 and the second finger 170 are connected to each other by a longitudinal micro-spring 202.

The micro-spring is made from a combination of two layers, a metal layer 206 and a dielectric layer 208. In particular embodiments, the metal layer 206 is a metal or metal alloy, such as and without limitation aluminum (Al) or an aluminum alloy, such as AlCu or AlSiCu; copper (Cu); tungsten (W); or nickel (Ni). In particular embodiments, the dielectric layer is made of silicon dioxide (SiO₂), although other materials can also be used. Generally speaking, the two layers have different or opposite tensile properties, and so can provide vibration isolation, resonance control, and damping and energy dissipation. This reduces the energy that is transmitted to the fingers due to external shocks. The angle formed between the micro-spring 202 and either finger 150, 170 is generally close to 90°. Each layer 206, 208 may have a height, in some embodiments, of about 0.5 μm.

The longitudinal micro-spring 202 has a length 203. In some particular embodiments, the length 203 may be from about 3 micrometers (μm) to about 6 μm. Other ranges are also within the scope of the present disclosure. Metal caps 196, 197 are also illustrated.

Each first finger has a free end 156 (or bottom end) and a fixed end 158 (or top end). Each second finger also has a free end 176 and a fixed end 178. The first finger has a height 163. The second finger has a height 183. As illustrated here, the heights 163, 183 of the two fingers are about the same. In some particular embodiments, the heights 163, 183 may independently range from about 150 micrometers (μm) to about 200 μm. Other ranges are also within the scope of the present disclosure. In addition, the two fingers 150, 170 are illustrated as being located so their top surfaces are at the same height or level. Again, this is not required for operation of the micromechanical arm array.

FIG. 3B is a magnified Y-axis cross-sectional view of the micromechanical arm array 148. It is noted that this is an extremely simplified illustration for purposes of description only, and is not fully representative of the complete micromechanical arm array. It is noted that the following discussion refers only to the first fingers 150, but applies equally to the second fingers 170.

As illustrated here, each first finger 150 includes a core 152, which is formed from an electrically conductive material. A cover layer 154 is present around all sides of the core 152, and isolates the core from the cavity. The cover layer may act as an etch stop layer, and is generally made from a dielectric material. In particular embodiments, the first and second fingers 150, 170 are made of polysilicon, and the cover layer is formed from silicon dioxide (SiO₂).

In this view, the first finger has a width 165. In some particular embodiments, the width 165 may independently range from about 1 micrometer (μm) to about 4 μm. Other ranges are also within the scope of the present disclosure.

Lateral micro-springs 204 are present between adjacent fingers 150, and the description of the longitudinal micro-springs above also applies to them. In some particular embodiments, their width 205 may be from about 3 micrometers (μm) to about 6 μm. This is also approximately the distance between adjacent fingers in the same array of fingers. Other ranges are also within the scope of the present disclosure. It is noted that the distance between adjacent fingers is generally about the same for the array of first fingers and the array of second fingers. The angle formed between the micro-spring 204 and either finger 150 is generally close to 90°.

It is noted that the metal layer 206 of the micro-spring 204 passes through the cover layer 154 and contacts the core 152. The thickness 155 of the cover layer, which corresponds to the overlap with the metal layer, in particular embodiments, is from about 0.3 micrometers (μm) to about 0.5 μm. It has also been discovered that when there is a minimum distance 195 between the metal cap 196 and the longitudinal and lateral micro-springs 202, 204 of about 4 μm, the stability of the springs is also increased. Other ranges are also within the scope of the present disclosure.

A passivation layer 201 is present upon the top surface 198 of the metal cap. As illustrated here, the metal cap 196 directly contacts the fixed ends 158 of the array of first electrically conductive fingers 150. The free ends 156, 176 of both arrays of fingers are able to move freely below the metal cap. The metal cap may be described as having a lower portion that directly contacts the first finger, and an upper portion that spans the distance between adjacent fingers. The width 199 of the upper portion of the metal cap is generally greater than the width 205 of the lateral micro-spring. In some particular embodiments, the width 199 of each upper portion of the metal cap is from about 3 μm to about 6 μm, although other ranges are also within the scope of the present disclosure. The width 200 of the lower portion of the metal cap is generally greater than the width 165 of the first finger 150. In some particular embodiments, the width 200 of the lower portion of the metal cap is from about 2 μm to about 5 μm, although other ranges are also within the scope of the present disclosure. Note that the upper portion(s) and the lower portion(s) of the metal cap overlap each other. It should also be noted that the metal cap is not rigid, and is merely used to keep the fingers separated.

FIG. 3C is a magnified Y-axis cross-sectional view of a second embodiment of the arm array 148. FIG. 3D is a magnified Y-axis cross-sectional view of a third embodiment of the arm array 148. These figures differ in the location of the lateral micro-spring 204. In FIG. 3B, the lateral micro-spring 204 is in a “high” position relative to the first finger 150, closest to the metal cap and within the upper ⅓ of the height of the first finger, near the fixed end 158. In FIG. 3C, the lateral micro-spring 204 is in a “medium” position relative to the first finger 150, within the middle ⅓ of the height of the first finger. In FIG. 3D, the lateral micro-spring 204 is in a “low” position relative to the first finger 150, furthest the metal cap and within the lower ⅓ of the height of the first finger, near the free end 156.

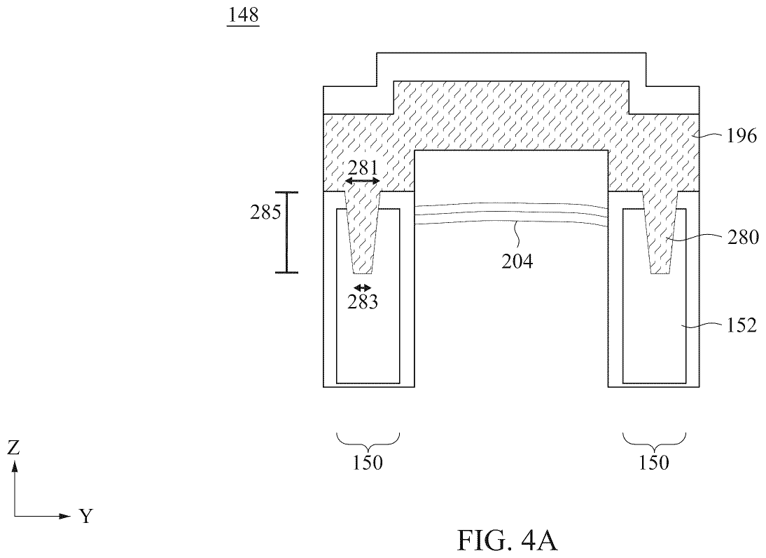

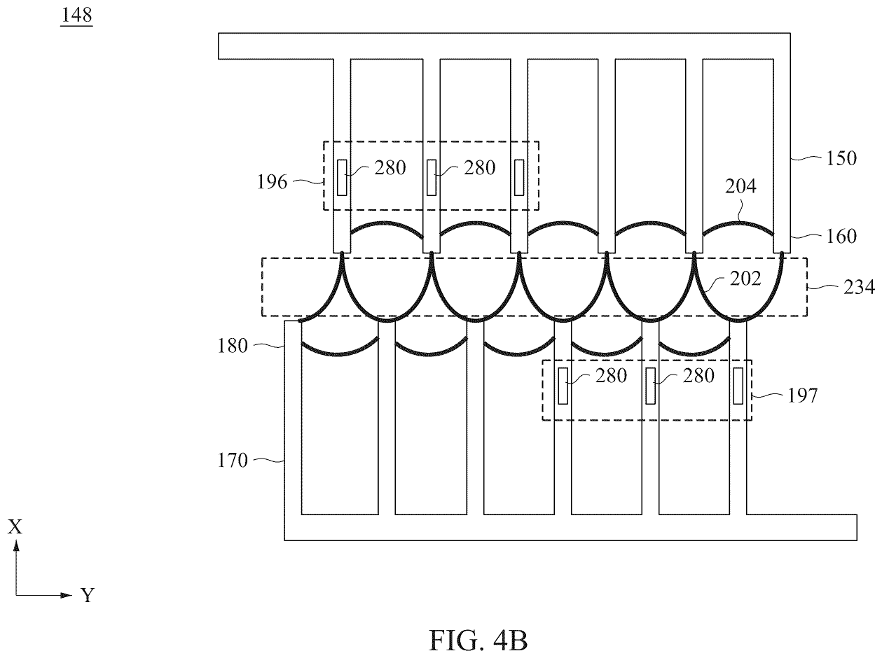

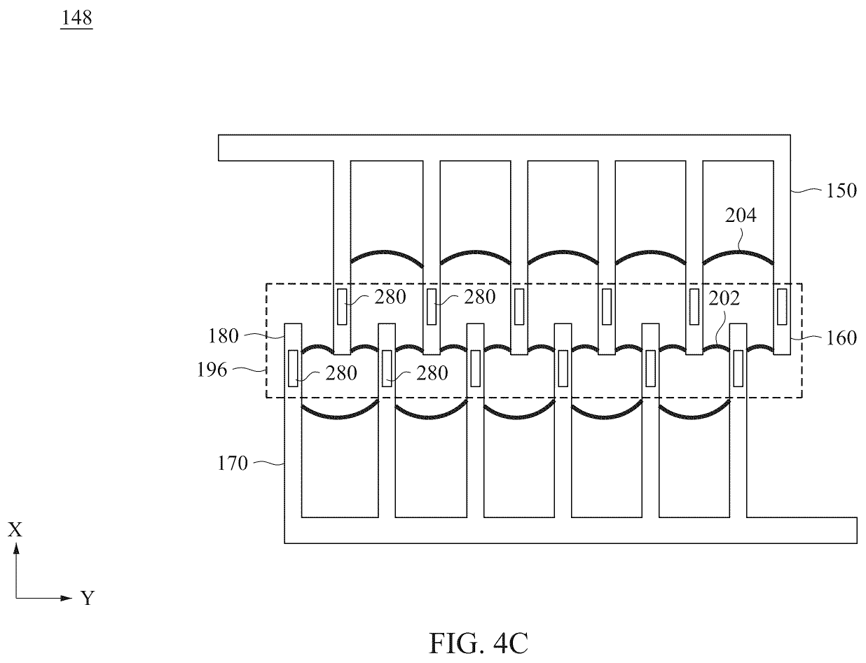

FIG. 4A is a plan view of an alternative embodiment of an arm array 148. Here, rivets 280 are present that extend from the metal cap 196 into the core 152 of the fingers 150. The rivets are made from the same material as the metal cap 196. In the embodiment illustrated here, each rivet 280 has an upper width 281 and a lower width 283. In some particular embodiments, the upper width 281 may be greater than the lower width 283. For example, the upper width 281 may be from about 2 μm to about 4 μm, and the lower width 283 may be from about 1 μm to about 3 μm. In other embodiments, the upper width 281 and the lower width 283 are about equal to each other, and in some examples are from about 1 μm to about 4 μm. In some embodiments, the rivet may have a height 285 of about 3 μm to about 10 μm, at least 4 μm. However, other ranges and are within the scope of the present disclosure.

FIG. 4B is a plan view of one potential embodiment of the arm array 148 of FIG. 4A. This embodiment is similar to that previously shown in FIG. 2B, where the distal ends 160 of the first fingers 150 do not overlap with the distal ends 180 of the second fingers 170, either horizontally or vertically. A lateral trench 234 lies between the two arrays of fingers 150, 170. Longitudinal micro-springs 202 and lateral micro-springs 204 are present. As illustrated, rivets 280 are present within the first fingers 150 and second fingers 170 below the respective metal caps 196, 197 (which are shown in dashed line). Variations in which rivets 280 are only present in the first fingers, or only in the second fingers, are also within the scope of the present disclosure.

FIG. 4C is a plan view of another potential embodiment of the arm array 148 of FIG. 4A. Again rivets 280 are present. Here, the distal ends 160 of the first fingers 150 can overlap horizontally with the distal ends 180 of the second fingers 170, or in other words they can be interposed or interlaced with each other. Longitudinal micro-springs 202 between the fingers of different arrays may be present, and lateral micro-springs 204 between adjacent fingers of the same array may be present. In this embodiment, it is possible that the first fingers 150 and second fingers 170 are covered by a common metal cap 196, which is shown in dashed line. Again, variations in which rivets 280 are only present in the first fingers, or only in the second fingers, are also within the scope of the present disclosure.

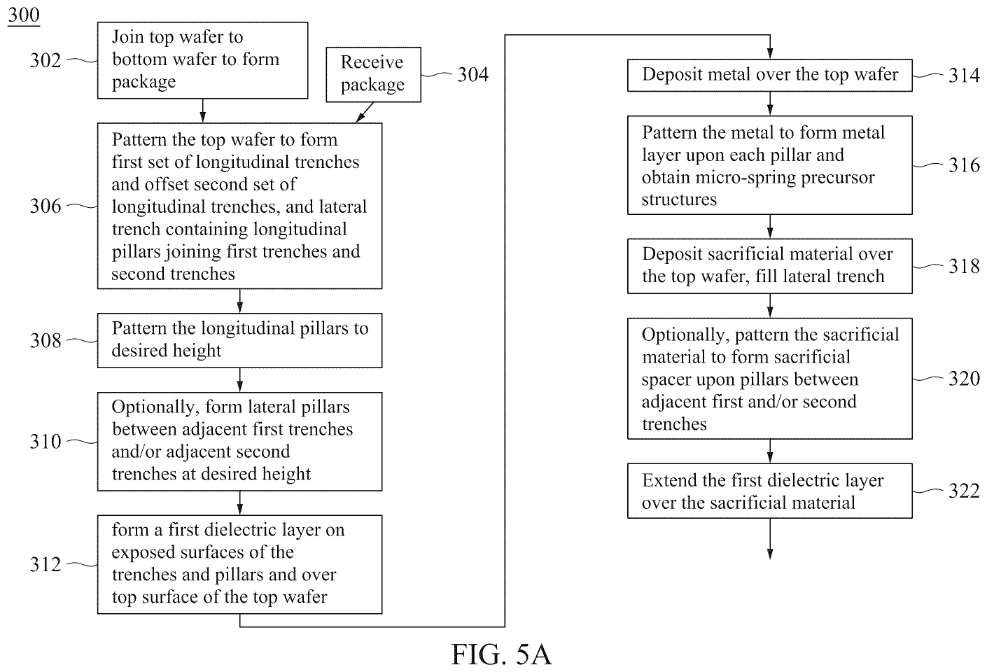

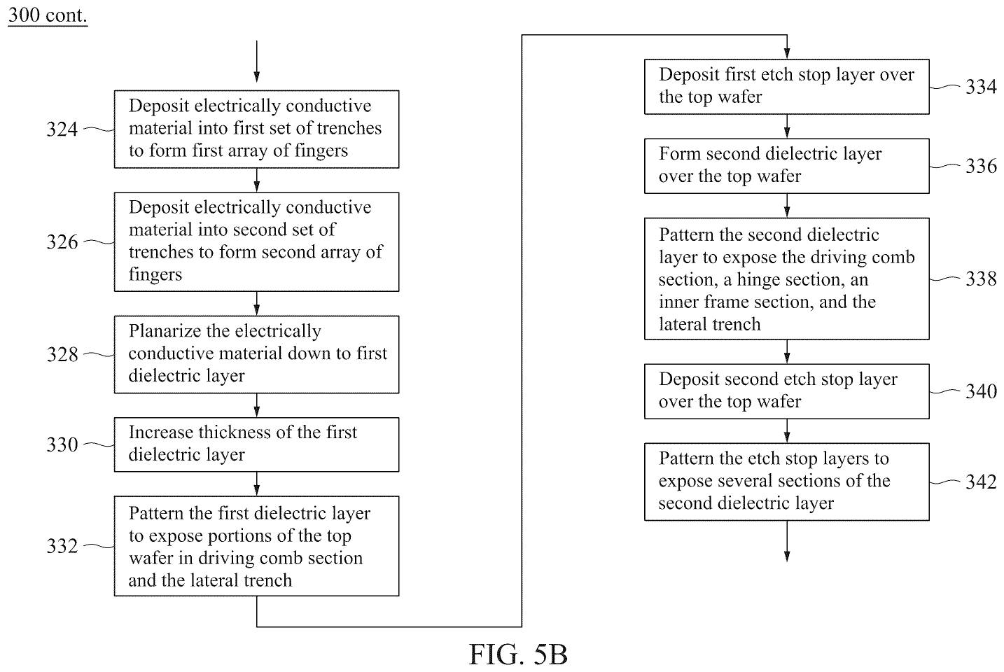

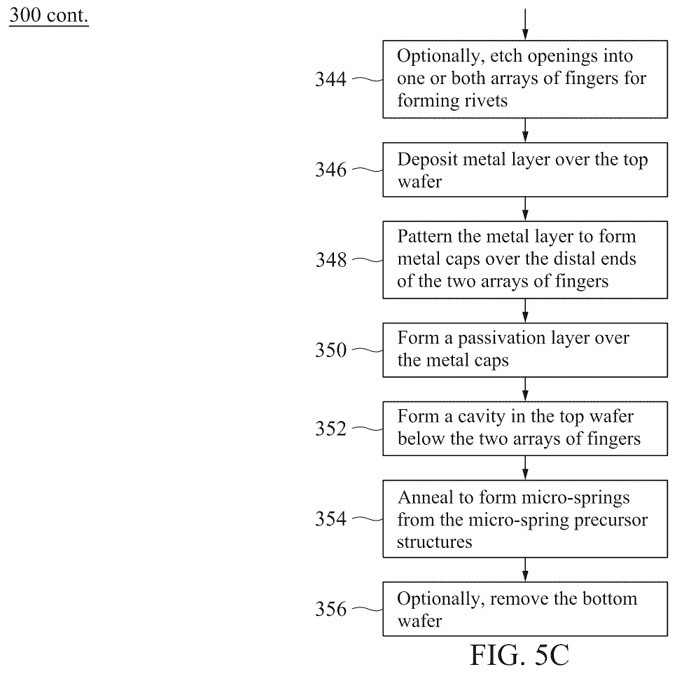

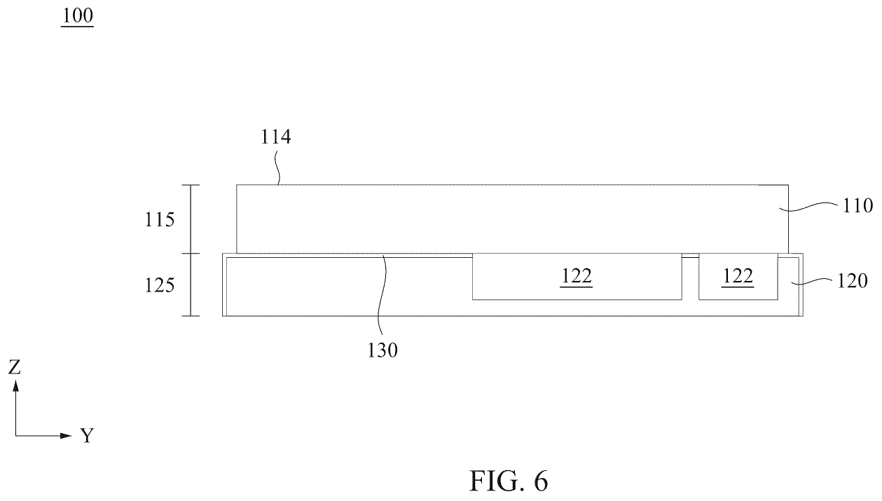

FIGS. 5A-5C together are a flow chart illustrating a first method 300 for making an arm array, in accordance with some embodiments. The arm array can be a micromechanical arm array, and can be used in various devices, such as a MEMS device. Some steps of the method are also illustrated in FIGS. 6-28B. These figures provide different views for better understanding. While the method steps are discussed below in terms of forming a single micromechanical arm array with a small number of fingers, such discussion should also be broadly construed as applying to the concurrent formation of multiple micromechanical arm arrays located in a single driving comb section, and also to the formation of many fingers in a single array. These figures do not show the formation of the entire actuator, only the driving comb section. In addition, methods using only some of the steps shown in the flow chart are contemplated as falling within the present disclosure.

Initially, in step 302 of FIG. 5A and as illustrated in FIG. 6, a top wafer 110 is joined to a bottom wafer 120 to form a package 100. Alternatively, as shown in step 304 of FIG. 5A, a package is received.

The top wafer 110 and the bottom wafer 120 may independently be, for example, a wafer made of a semiconducting material. Such semiconductor materials can include silicon, for example in the form of crystalline Si. In alternative embodiments, the substrate can be made of other elementary semiconductors such as germanium, or may include a compound semiconductor such as silicon carbide (SiC), gallium arsenide (GaAs), gallium carbide, gallium phosphide, indium arsenide (InAs), indium phosphide (InP), silicon germanium, silicon germanium carbide, gallium arsenic phosphide, or gallium indium phosphide. In particular embodiments, the two wafers are made of silicon.

The top wafer includes a top surface 114 which also acts as the top surface of the package. Generally, the top wafer 110 has a relatively lower thickness 115 (for example in the range of about 200 μm) which results in the top wafer being very flexible and thus difficult to process by itself. The bottom wafer 120 has a relatively higher thickness 125 (for example in the range of about 500 μm) that increases the overall thickness of the package and thus provides mechanical stability during processing, and can also aid in electrical isolation (if desired). Two cavities 122 are already present within the bottom wafer 120. The bonding layer 130 may be formed by fusion bonding, for example, by a heating and/or pressing process without any additional layers. As another example, both wafers may have a dielectric layer on appropriate surfaces which are then heated. The two wafers are then pressed together to form the bonding layer.

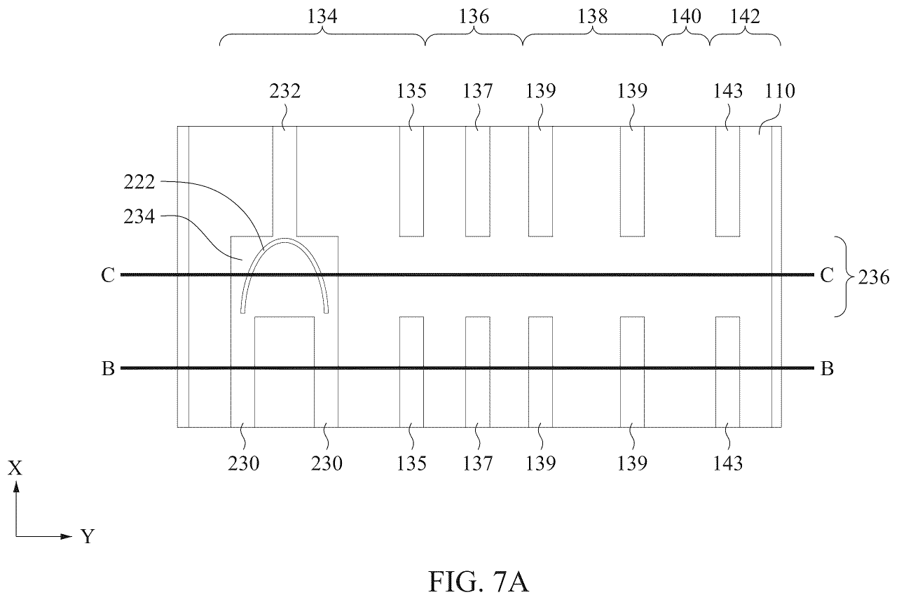

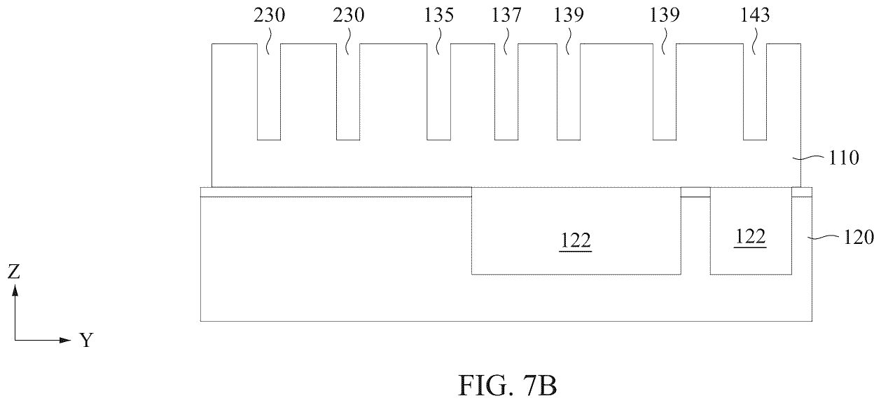

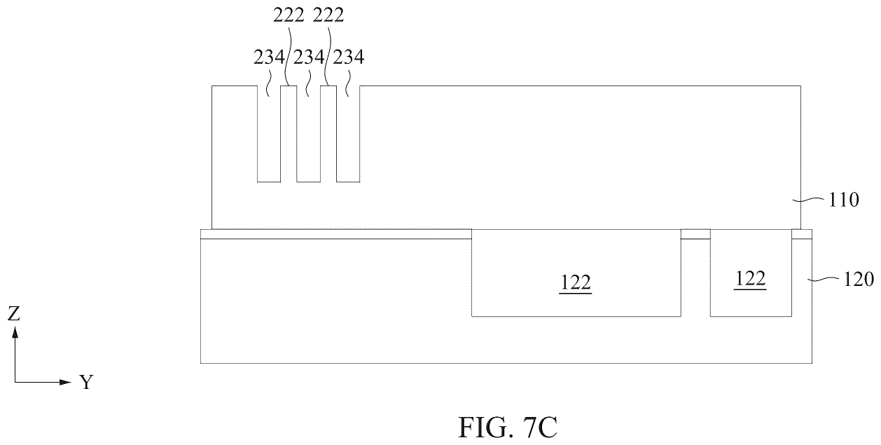

Next, in step 306 of FIG. 5A and as illustrated in FIGS. 7A-7C, the top wafer 110 is patterned to form multiple structures. They include a set of first longitudinal trenches 230, a set of second longitudinal trenches 232, and a lateral trench 234. One or more longitudinal pillars 222 are formed within the lateral trench. The two sets of trenches 230, 232 will correspond to the two different arrays of fingers. There is an area 236 between the two sets of trenches. As illustrated here, the longitudinal pillars 222 connect the first trenches 230 to the second trench 232. The first trenches 230, second trenches 232, and lateral trench 234 are part of the driving comb section 134. Additional trenches 135 are also formed in the driving comb section. Additional trenches 137, 139, 143 are also formed in the top wafer in locations which will correspond to the hinge section 136, the inner frame section 138, and the outer frame section 142. The longitudinal pillars correspond to locations where the longitudinal micro-springs will be formed. The resulting structure is illustrated in FIGS. 7A-7C.

FIG. 7B is a side cross-sectional view of the package through line B-B of FIG. 7A. This cross-section passes through the location where the lateral micro-spring will be formed. In this cross-section, only the trenches 230 for the first fingers are visible. FIG. 7C is a side cross-sectional view of the package through line C-C of FIG. 7A. This cross-section passes through the location where the longitudinal micro-springs will be formed. The trenches 230, 232 for the first fingers and the second fingers are not visible. It is noted that the additional trenches 137, 139, 143 are not visible here either, and do not pass through this section of the top wafer.

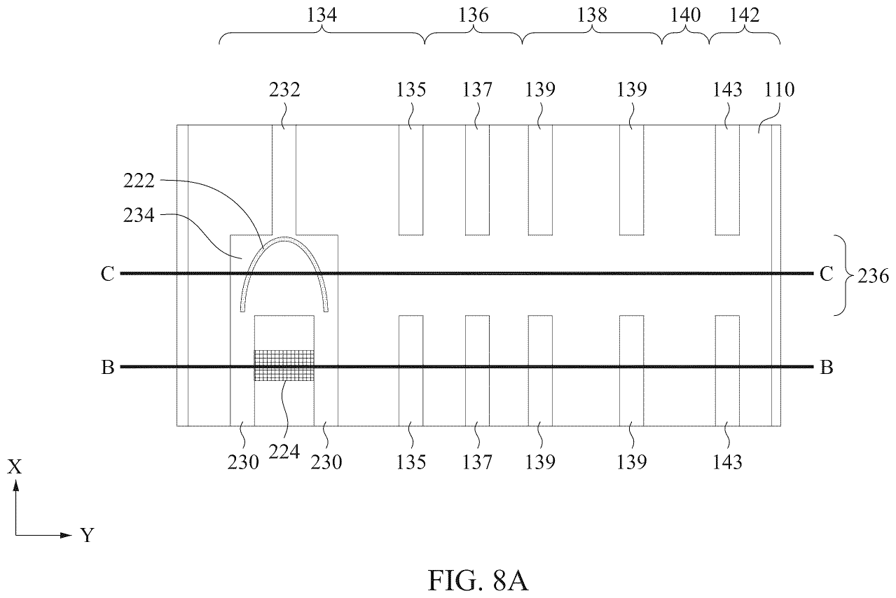

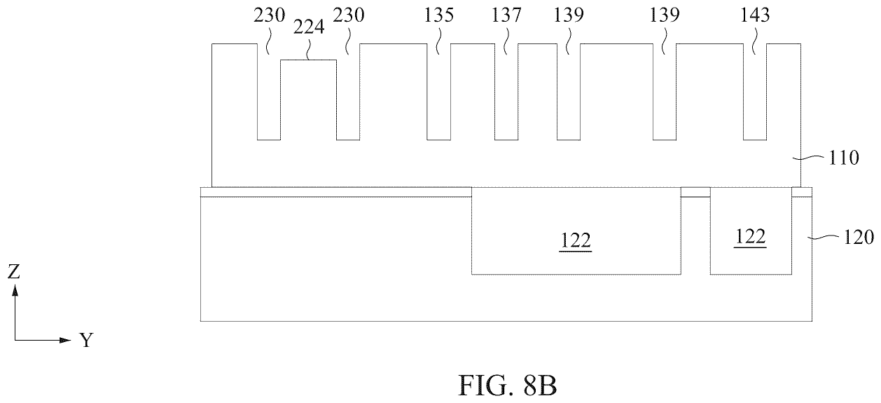

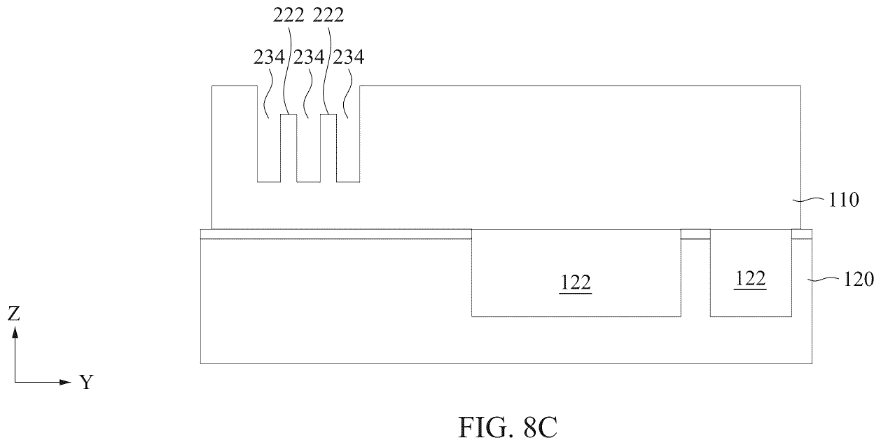

Next, in step 308 of FIG. 5A, the longitudinal pillars 222 are patterned to a desired height. In optional step 310 of FIG. 5A, if desired, lateral pillars 224 are patterned into the top wafer to a desired height. The resulting structure is illustrated in FIGS. 8A-8C.

FIG. 8A is a plan view of the package after these two patterning/etching steps. The different depths of the trenches 230, 232 and the longitudinal pillars 222 and the lateral pillar 224 are indicated with different shading. FIG. 8B and FIG. 8C show that the longitudinal pillars 222 and the lateral pillars 224 may be patterned to have different heights from each other if desired. However, it is contemplated that if they have the same heights, then only one patterning/etching operation is required.

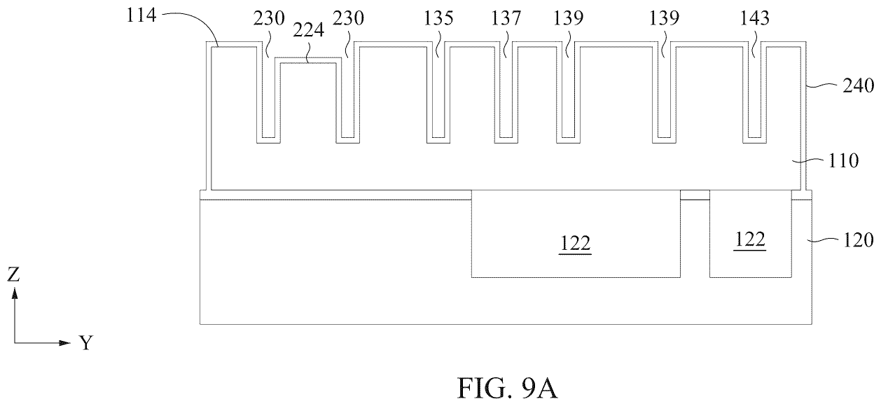

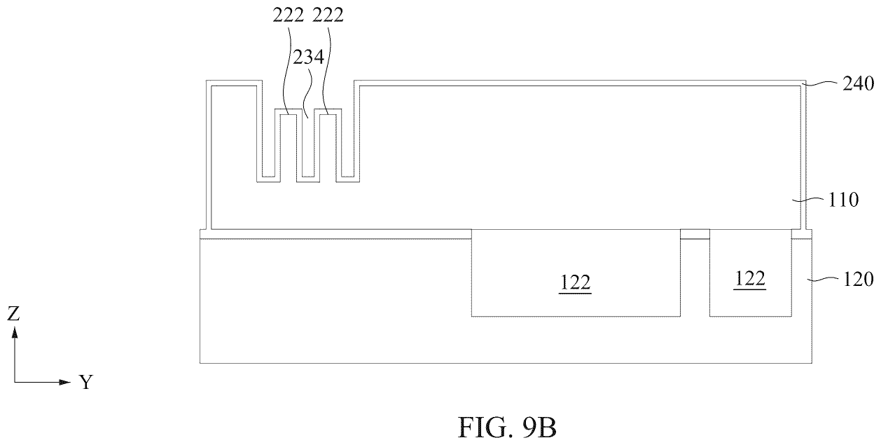

Next, in step 312 of FIG. 5A and as illustrated in FIG. 9A and FIG. 9B, a first dielectric layer 240 is formed on the exposed surfaces of the trenches 230, 232 and pillars 222, 224. The first dielectric layer is also formed on the other exposed surfaces of the top wafer 110, including the top surface 114. In particular embodiments, the first dielectric layer is made of silicon dioxide (SiO₂), which can be formed by thermal oxidation of the silicon wafer. Of particular note, the portion of the first dielectric layer 240 upon the pillars 222, 224 will form the dielectric layer 208 of the micro-spring.

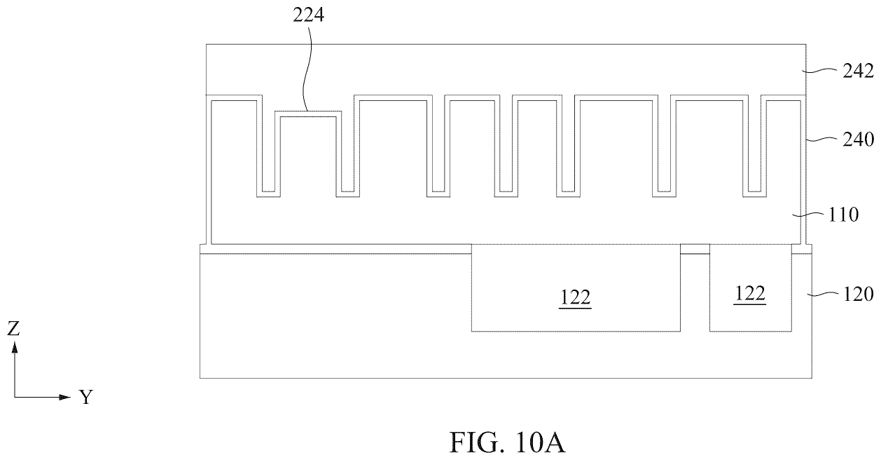

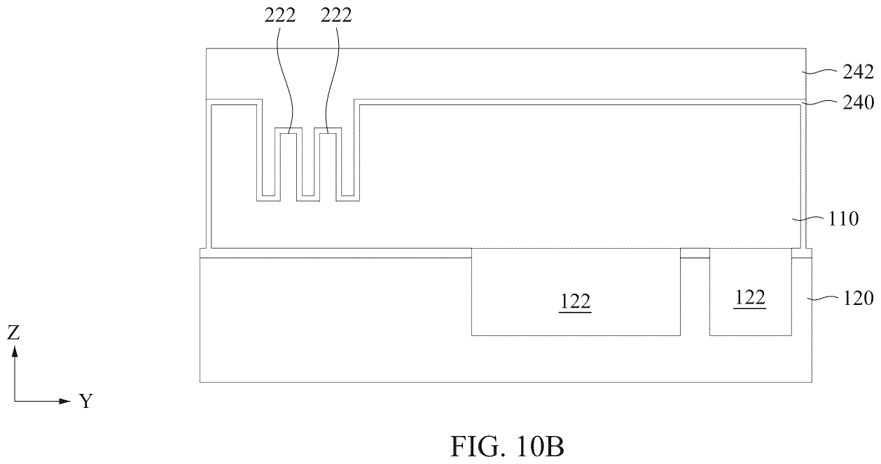

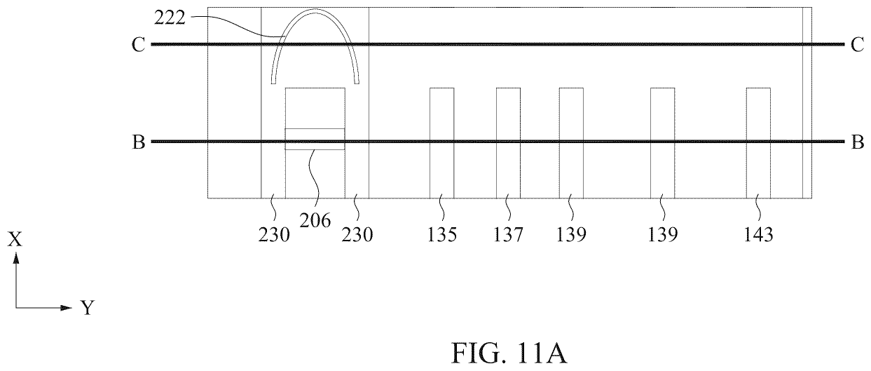

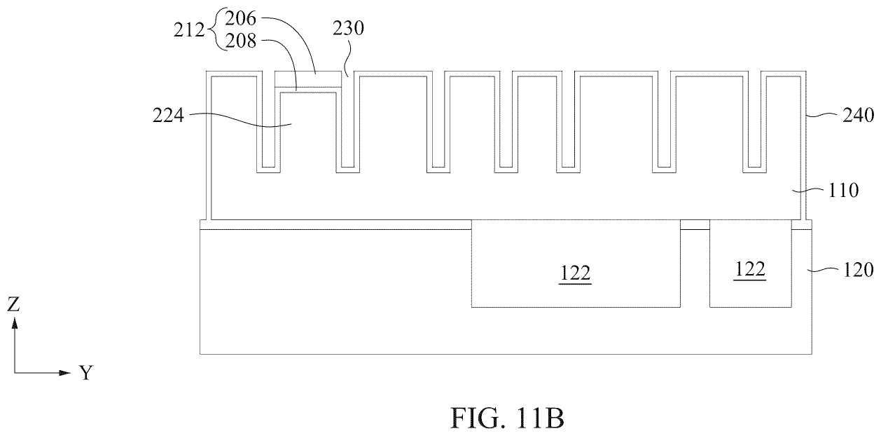

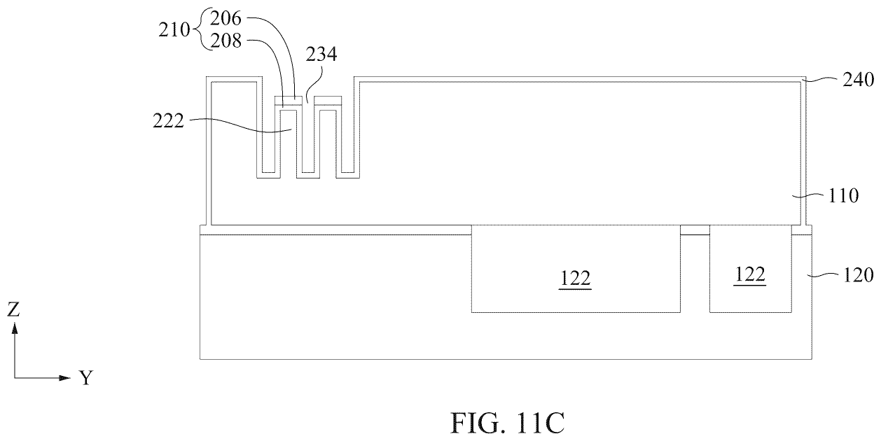

Next, in step 314 of FIG. 5A and as illustrated in FIG. 10A and FIG. 10B, metal 242 is deposited over the top wafer. Then, in step 316 of FIG. 5A and as illustrated in FIGS. 11A-11C, the metal is patterned to form a metal layer 206 upon each pillar 222, 224. This metal layer will form the metal layer of the micro-spring. In particular embodiments, the metal is aluminum (Al) or an aluminum alloy, such as AICu or AlSiCu. The metal may be deposited, for example, via evaporation or sputtering, plating, chemical vapor deposition (CVD), physical vapor deposition (PVD), atomic layer deposition (ALD), or other suitable methods. As better seen in FIG. 11B and FIG. 11C, the metal layer 206 is present only upon the pillars 222, 224, and not in the trenches 230, 232, 234 within the recess. The combination of the dielectric layer 208 and the metal layer 206 upon each pillar is also referred to herein as a micro-spring precursor structure or a horizontal composite structure. A lateral micro-spring precursor structure 212 is seen in FIG. 11B, and a longitudinal micro-spring precursor structure 210 is seen in FIG. 11C. It is noted that these micro-spring precursor structures 210, 212 are illustrated as being formed at different heights from each other, with the lateral micro-spring precursor structure 212 being higher than the longitudinal micro-spring precursor structure 210. However, this is not required.

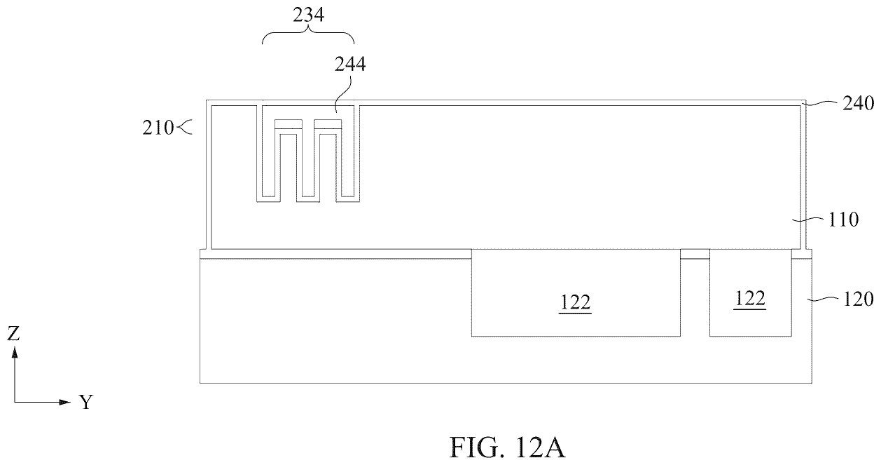

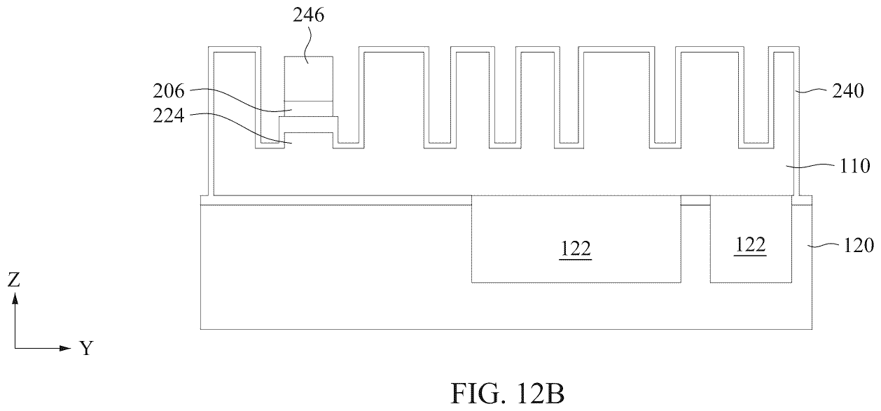

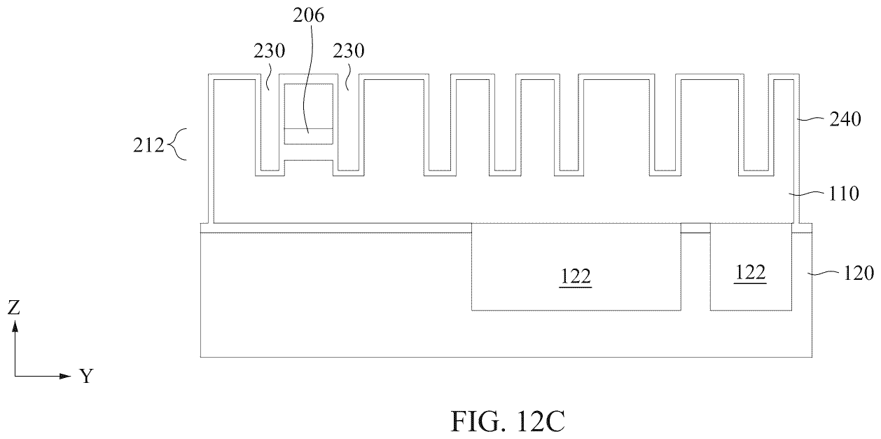

Continuing, in step 318 of FIG. 5A and as illustrated in FIG. 12A, a sacrificial material 244 is deposited over the top wafer, including within the lateral trench 234. The sacrificial material may be deposited using CVD, PVD, or other suitable methods. In particular embodiments, the sacrificial material is the same material as the top wafer, such as silicon. If the lateral pillars 224 are placed at a different height from the longitudinal pillars, then in optional step 320 of FIG. 5A and as illustrated in FIG. 12B, the sacrificial material may also be patterned to form a sacrificial spacer 246 upon the lateral pillars 224.

In step 322 of FIG. 5A and as illustrated in FIG. 12A and FIG. 12C, a dielectric layer is formed on the exposed surfaces of the metal layers 206 and the sacrificial material and sacrifical spacers 246. This step may be considered as adding to the first dielectric layer 240. In particular embodiments, this is done by thermal oxidation of the exposed surfaces. As a result, as seen in FIG. 12A, generally the longitudinal micro-spring precursor structures 210 are buried. As seen in FIG. 12C, the trenches 230 within each set of trenches are completely separated from each other. The lateral micro-spring precursor structures 212 may be buried, or may not, depending on its height.

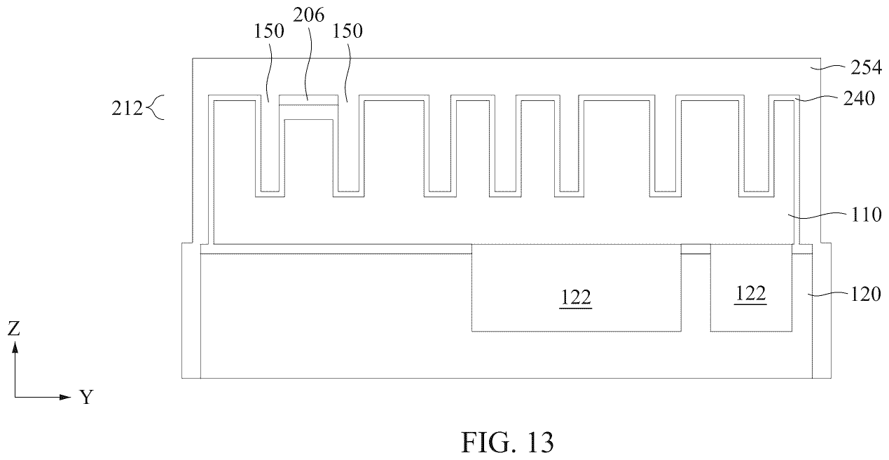

Next, in step 324 of FIG. 5B and as illustrated in FIG. 13, an electrically conductive material is deposited into the first set of trenches to form the array of first fingers 150. In step 326, an electrically conductive material is deposited into the second set of trenches to form the array of second fingers. Referring back to FIG. 2B, the first arm 168 and the second arm 188 are also formed in these steps. The deposition may be performed using CVD, PVD, or other suitable methods. Examples of suitable materials include electrically conductive materials such as polysilicon, metals, or piezoelectric materials such as barium titanate (BaTiO₃, BTO), lead titanate (PbTiO₃), lead zirconium titanate (PZT), or potassium sodium niobate (KNN). The first fingers and second fingers may be made of the same or different materials, as desired. If they are made of the same materials, then only one deposition operation is required. As illustrated in FIG. 13, an electrically conductive material layer 254 is also formed over the top wafer.

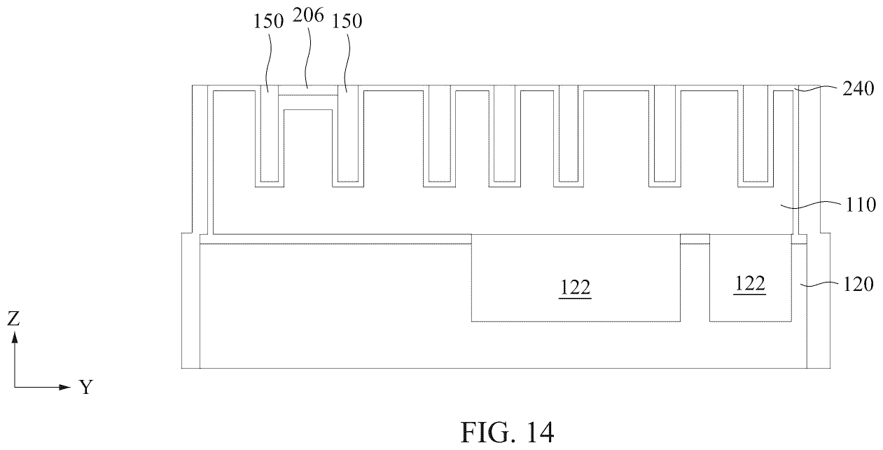

In step 328 of FIG. 5B and as illustrated in FIG. 14, the electrically conductive material layer is planarized down to the first dielectric layer 240. The first dielectric layer acts as an etch stop layer for this step. This may be done, for example, by chemical mechanical polishing (CMP), where the surface of a wafer is leveled using relative motion between the wafer and a rotating polishing pad to which a slurry is applied. Downward pressure is applied to push the wafer against the polishing pad, and elevated elements are worn down to obtain a surface with low surface roughness. As a result, the first fingers 150 are exposed.

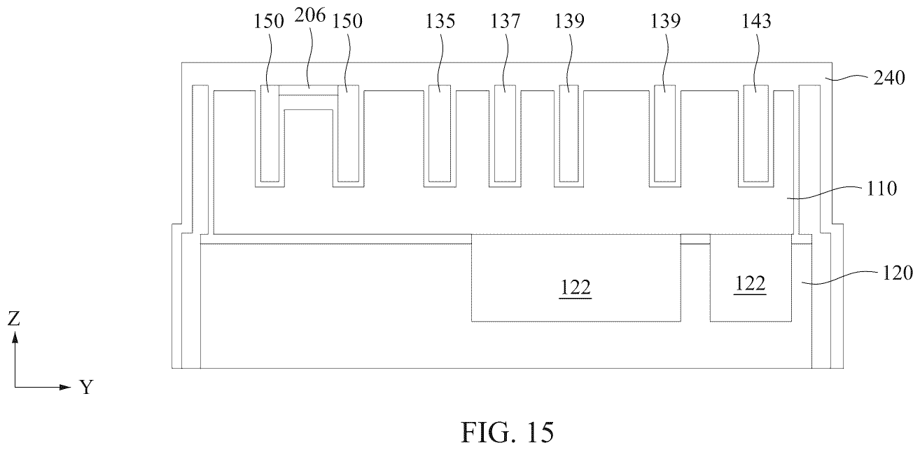

Subsequently, in step 330 of FIG. 5B and as illustrated in FIG. 15, a dielectric layer is formed over the top wafer. This step may be considered as increasing the thickness of the first dielectric layer 240. In particular embodiments, this is done by CVD or PVD. The addition to the first dielectric layer occurs over the first fingers 150, the second fingers 170 (not shown), and over the other trenches 135, 137, 139, 143 in the top wafer as well.

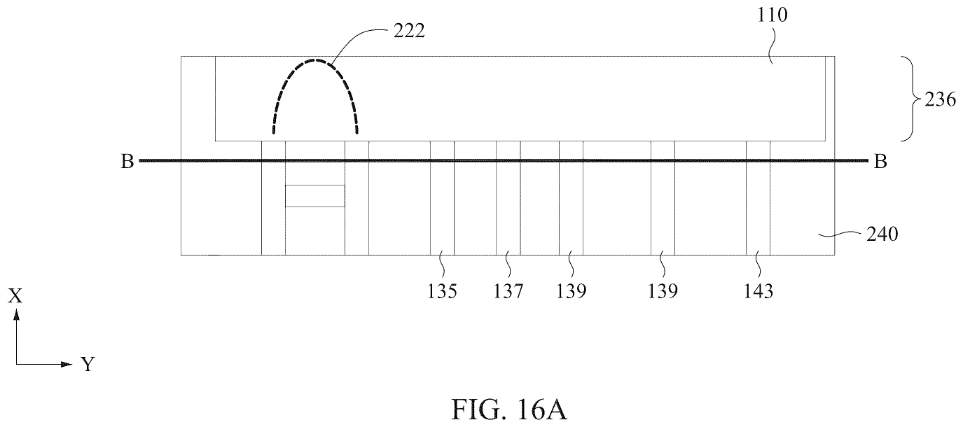

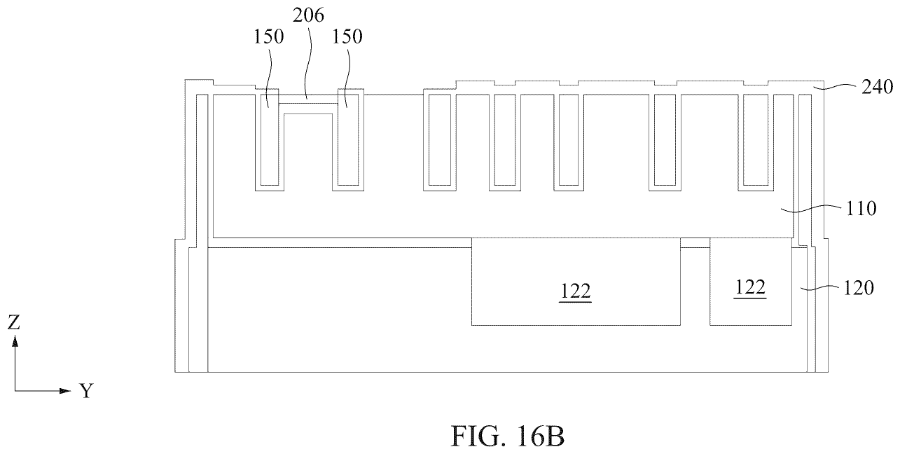

Then, in step 332 of FIG. 5B and as illustrated in FIG. 16A and FIG. 16B, the first dielectric layer 240 is patterned to expose portions of the top wafer 110 within the driving comb section 134. As will be seen later, this is done to permit the silicon to be removed later. Portions of the first dielectric layer are removed from the driving comb section to expose the top wafer. It is noted that the patterning of the first dielectric layer may be performed in multiple steps if desired, such that the first dielectric layer has different thicknesses on different areas on the top wafer. As illustrated in FIG. 16A, the longitudinal pillars 222 are still buried under the silicon, as indicated by the dashed lines. Of particular note, the first dielectric layer is illustrated as removed from the area 236 between the two arrays of fingers, but this is not required. The first fingers 150 and the second fingers (not shown) remain covered by the first dielectric layer. The locations of the various trenches 135, 137, 139, 143 are also indicated. As illustrated in FIG. 16B, the metal layer 206 of the lateral micro-spring precursor structure is also exposed.

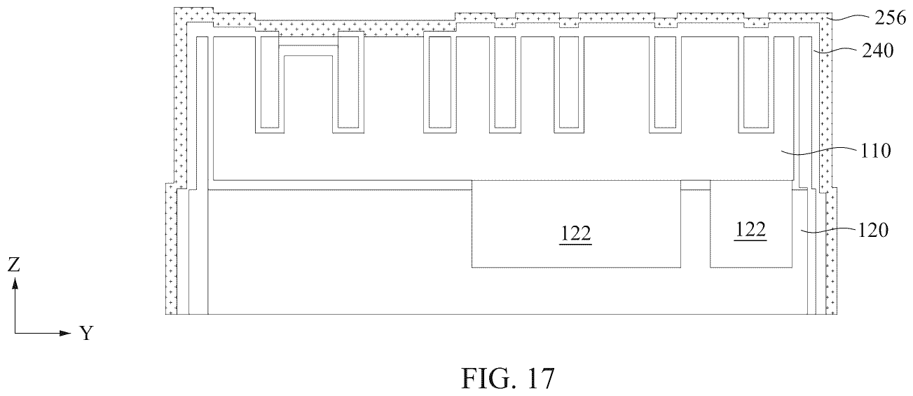

Next, in step 334 of FIG. 5B and as illustrated in FIG. 17, a first etch stop layer 256 is deposited over the top wafer. The deposition may be performed using CVD, PVD, or other suitable methods. The first etch stop layer may be made of any material that is different from the material of the first dielectric layer 240, such as a different dielectric material or an electrically conductive material. In particular embodiments, the first stop etch layer is made of polysilicon.

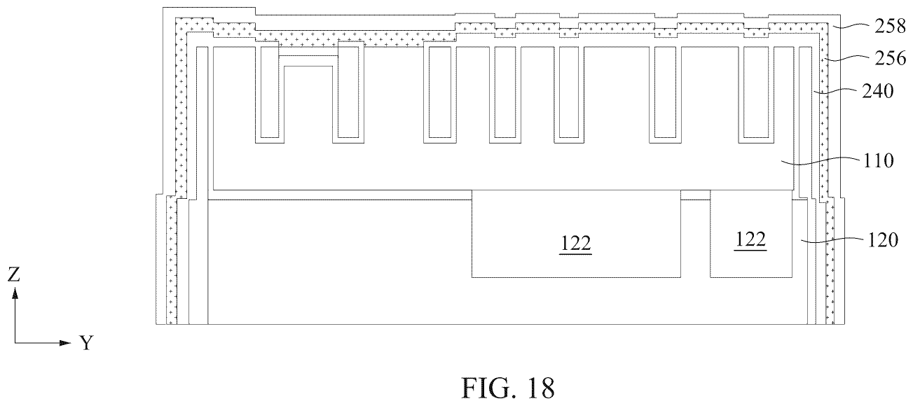

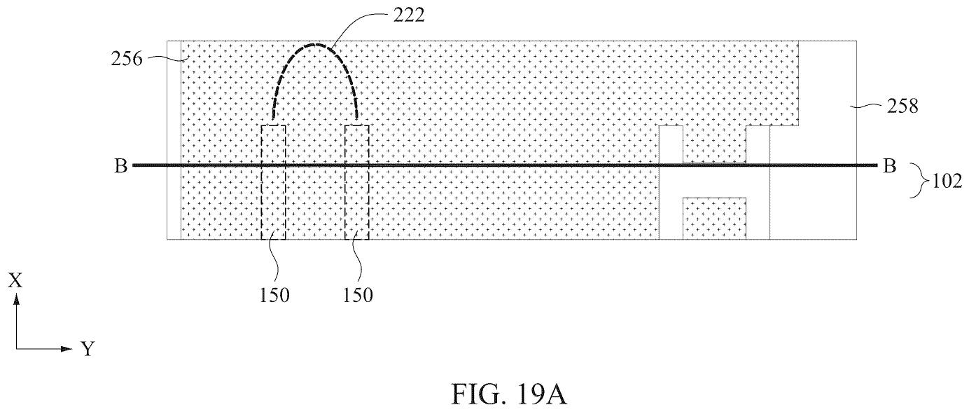

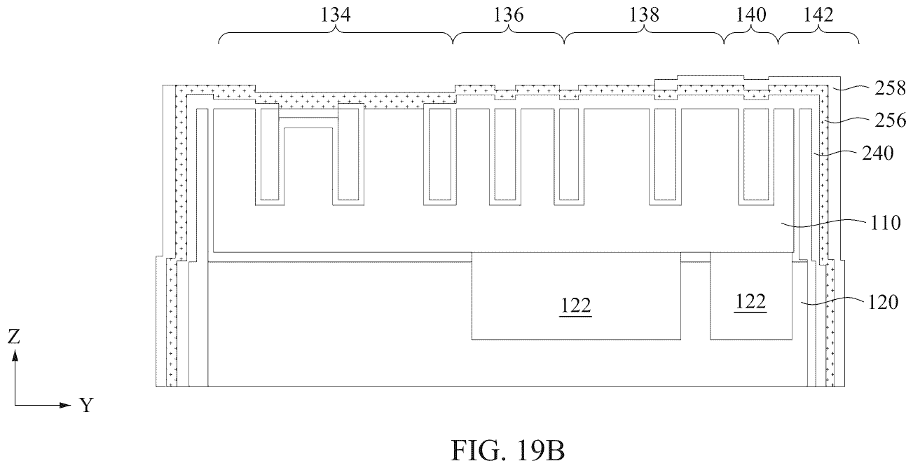

In step 336 of FIG. 5B and as illustrated in FIG. 18, a second dielectric layer 258 is formed over the first etch stop layer 256. This may be done by deposition such as CVD, PVD, or other suitable methods. Then, in step 338 of FIG. 5B and as illustrated in FIG. 19A and FIG. 19B, the second dielectric layer is patterned to expose the driving comb section 134, the hinge section 136, and a portion of the inner frame section 138. Put another way, the second dielectric layer is removed from these three sections. As a result, the second dielectric layer 258 remains upon a portion of the inner frame section 138, the spring section 140 and the outer frame section 142. In the spring section 140, the second dielectric layer 258 is present across a central section 102. The first etch stop layer 256 is exposed where the second dielectric layer has been removed. In particular embodiments, the first dielectric layer 240 and the second dielectric layer 258 are made of the same material.

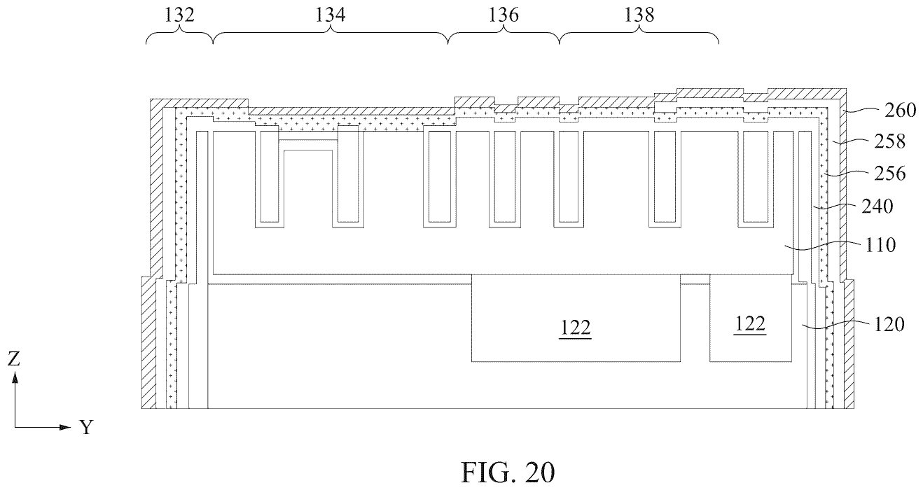

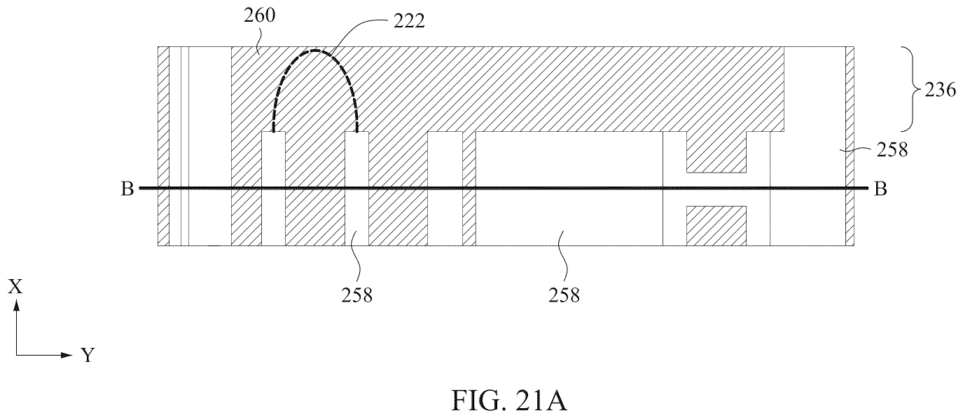

Next, in step 340 of FIG. 5B and as illustrated in FIG. 20, a second etch stop layer 260 is deposited over the top wafer. The deposition may be performed using CVD, PVD, or other suitable methods. In particular embodiments, the second etch stop layer is made of the same material as the first etch stop layer 256. As illustrated here, then, there are several locations in the anchor arm section 132, the driving comb section 134, the hinge section 136, and the inner frame section 138 where the two etch stop layers 256, 260 directly contact each other.

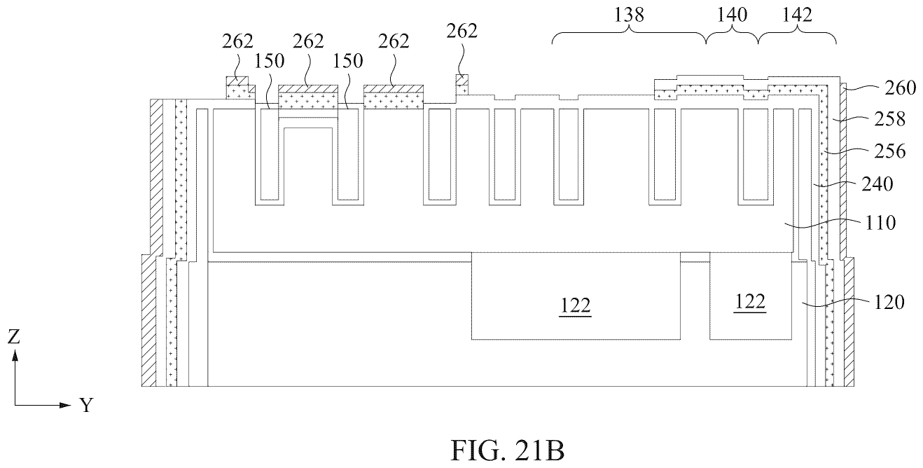

Then, in step 342 of FIG. 5B and as illustrated in FIG. 21A and FIG. 21B, the two etch stop layers are patterned to form vertical spacers 262 within the driving comb section. As seen here, spacers 262 are present over the portions of the top wafer 110 between the arrays of fingers 150, 170 in the driving comb section 134. As seen in FIG. 21A, the two etch stop layers are exposed in the area 236 between the two arrays of fingers. As seen in FIG. 21B, the second dielectric layer 258 is now exposed in the inner frame section 138, the spring section 140, and the outer frame section 142.

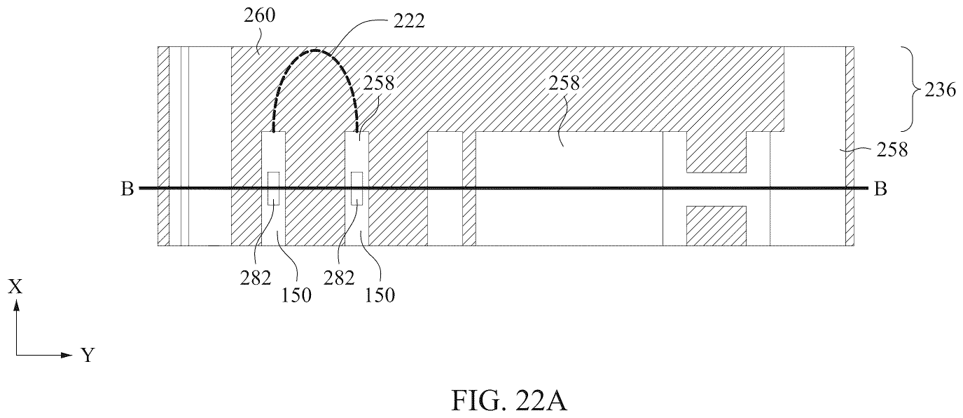

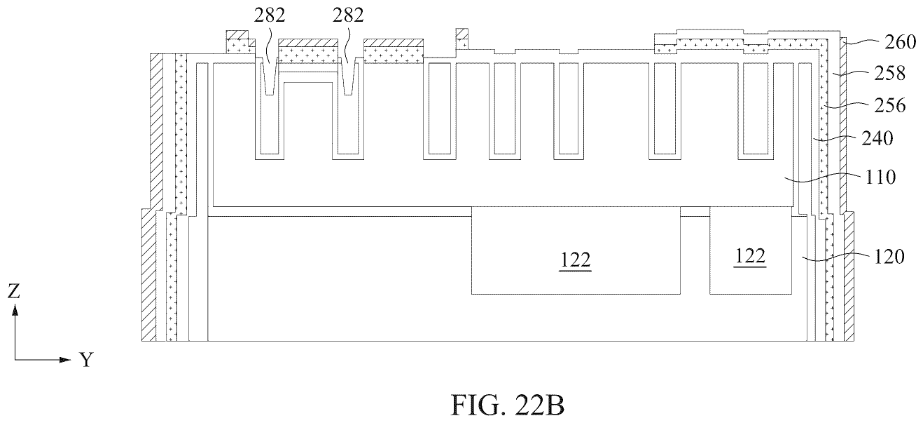

In optional step 344 of FIG. 5C and as illustrated in FIG. 22A and FIG. 22B, openings 282 may be etched into the first fingers 150 and/or the second fingers 170 (not shown). The openings extend from the upper surface into the core of the finger(s). This may be done by etching or other suitable process such as laser drilling.

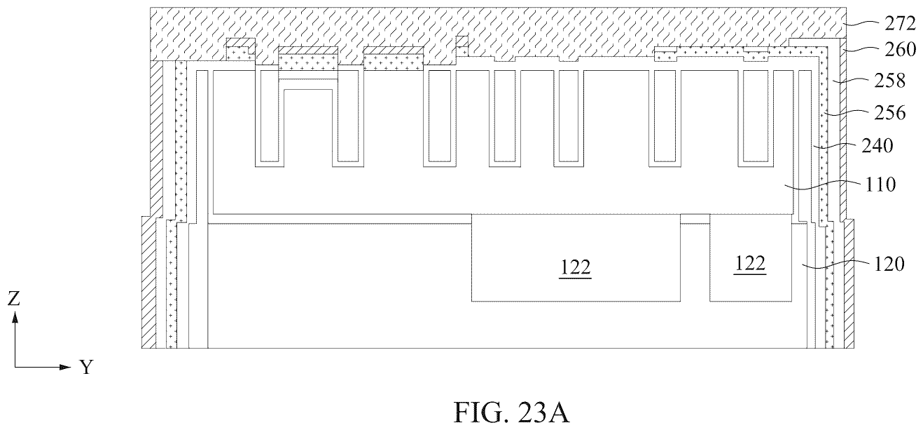

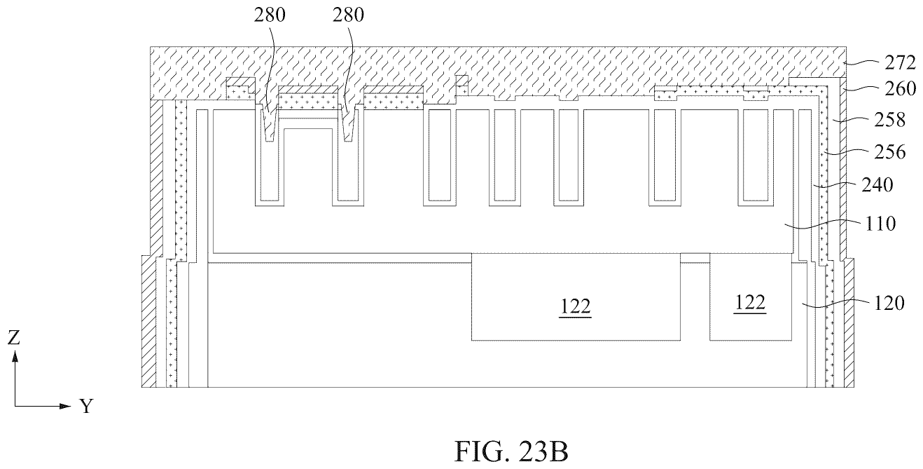

In step 346 of FIG. 5C and as illustrated in FIG. 23A, a metal layer 272 is deposited over the top wafer 110. The deposition may be performed using CVD, PVD, or other suitable methods. FIG. 23B shows the result after this deposition if the optional step 344 was performed. Rivets 280 can be seen here.

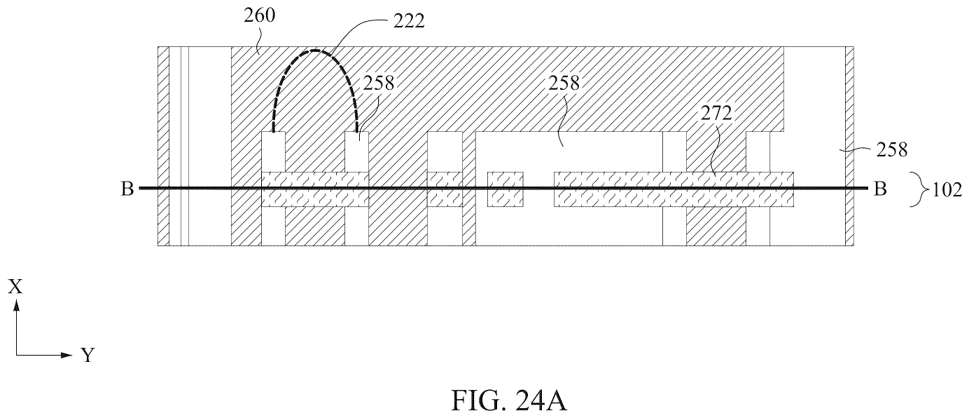

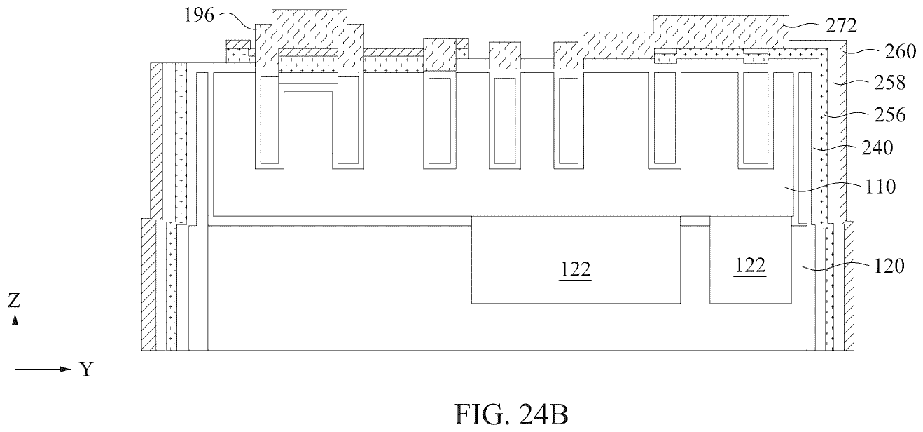

Then, in step 348 of FIG. 5C and as illustrated in FIG. 24A and FIG. 24B, the metal layer is patterned to form a metal cap 196 over one or both of the two arrays of fingers 150. The metal layer is also patterned to remain in a central section 102 upon the other trenches 135, 137, 139, 143 in the driving comb section 134, the hinge section 136, the inner frame section 138, the spring section 140, and the outer frame section 142. It is noted that the metal cap 196 has two different heights; this can be obtained through two consecutive mask/etch steps. The location of the buried longitudinal micro-spring precursor structures 210 are also indicated for reference.

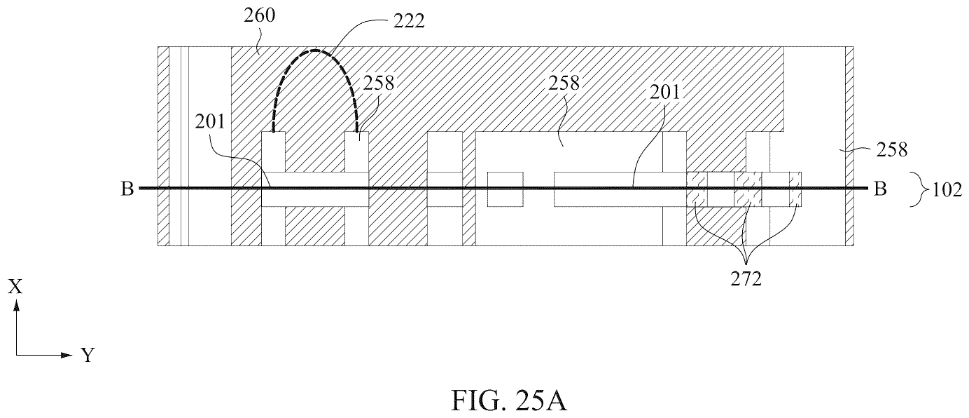

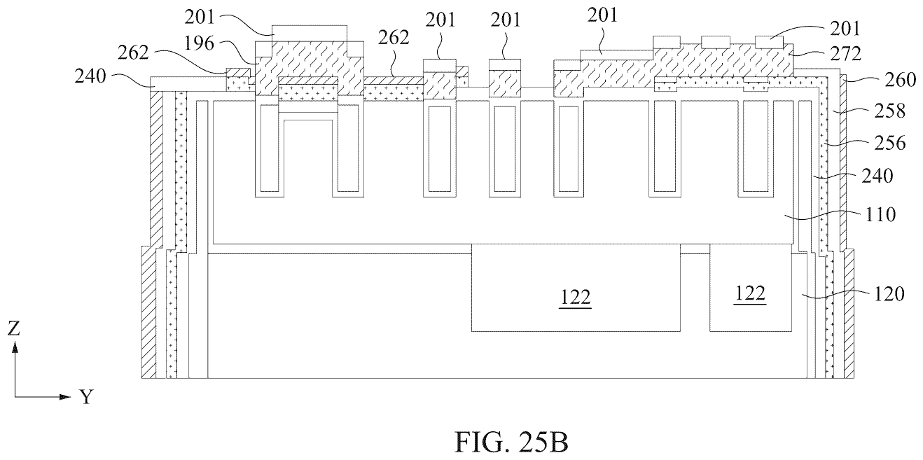

Next, in step 350 of FIG. 5C and as illustrated in FIG. 25A and FIG. 25B, a passivation layer 201 is formed upon the metal cap 196. The passivation layer 201 is also formed upon the metal layer 272 in the driving comb section 134, the hinge section 136, the inner frame section 138, the spring section 140, and the outer frame section 142. The passivation layer may be formed by deposition of another dielectric layer and patterning to remove the dielectric layer from undesired locations. Although not visible, the passivation layer is also present upon the sides of the metal cap 196 and the metal layer 272.

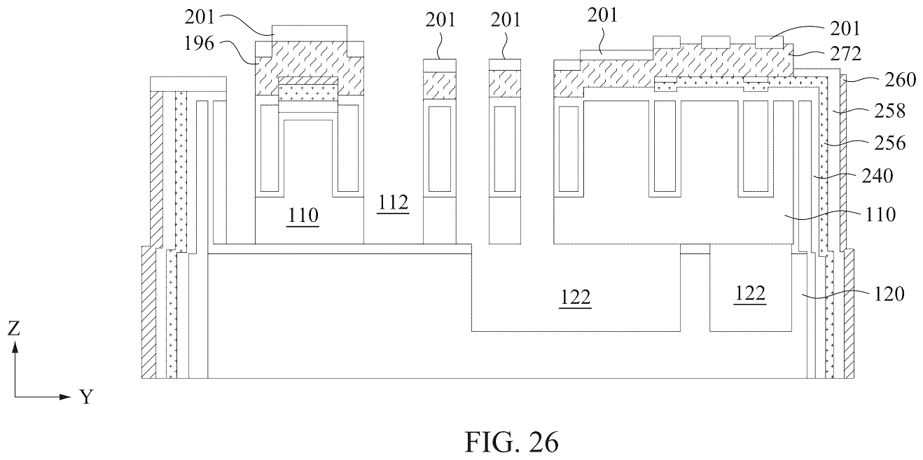

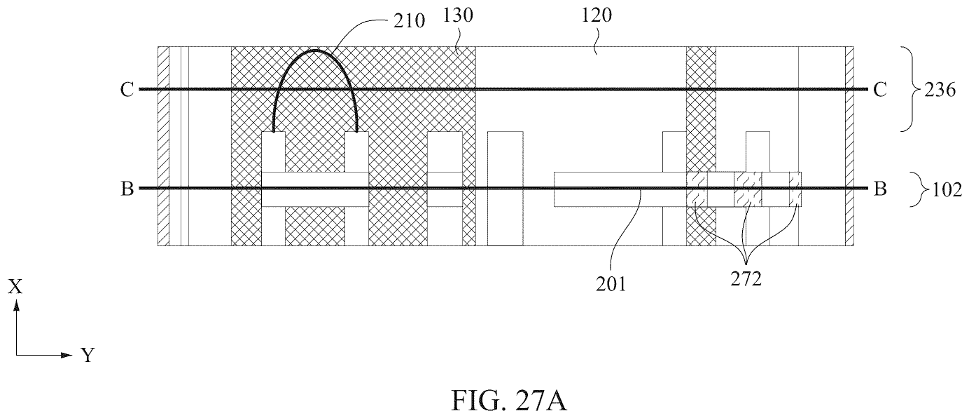

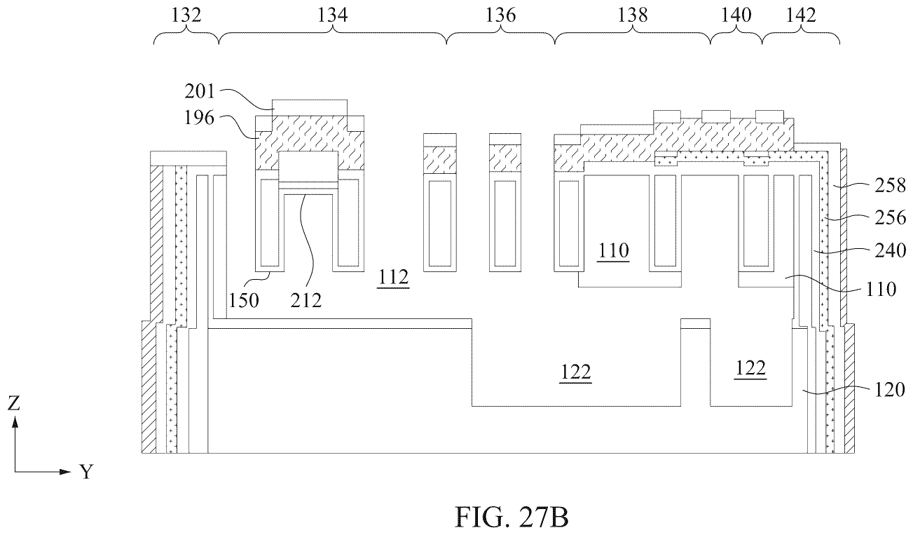

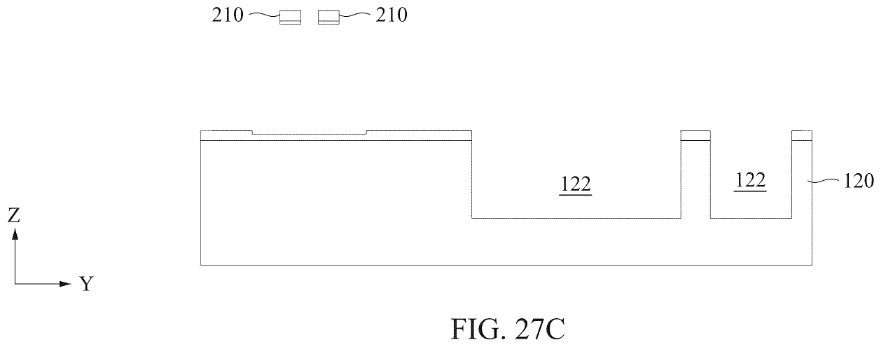

Then, in step 352 of FIG. 5C and as illustrated in FIG. 26 and FIGS. 27A-27C, a cavity 112 is formed in the top wafer 110 below the two arrays of fingers 150. This may be done, for example, by patterning the top wafer, then etching through the exposed vertical spacers 262 (see FIG. 25B) and the first dielectric layer 240 below the vertical spacers using a dry etch process as seen in FIG. 26. Then, the silicon is completely etched using a wet etch process, as illustrated in FIGS. 27A-27C. Some areas underneath the metal cap 196 and the metal layer 272 are etched because they are exposed from the sides (see FIG. 25A), while others are not exposed and thus are not etched. In this regard, the wet etch process can be controlled by timing. After the wet etchant etches through the top wafer, the cavities 122 in the bottom wafer provide a volume to collect and neutralize the wet etchant. The material of the top wafer is also etched in the hinge section 136 and the spring section 140. Some undercutting may occur, which is acceptable. As a result of this etching step, the micro-spring precursor structures 210, 212 are released from the top wafer and the two etch stop layers as well. In the plan view of FIG. 27A, the bonding layer 130 and portions of the bottom wafer 120 are also visible. As seen in FIG. 27C, the top wafer is completely etched away in the area 236 between the two arrays of fingers, and only the longitudinal micro-spring precursor structures 210 are present in this area. The longitudinal pillar (formed of silicon) is etched away in this step. Any dielectric layer resting on the silicon may also be removed.

Next, in step 354 of FIG. 5C, annealing is performed. The annealing step may be performed in a heating chamber at an elevated temperature (e.g., from about 800° C. to about 1,600° C.). As a result, micro-springs 202, 204 are formed from the micro-spring precursor structures. The resulting micromechanical arm array 148 is shown in FIG. 1.

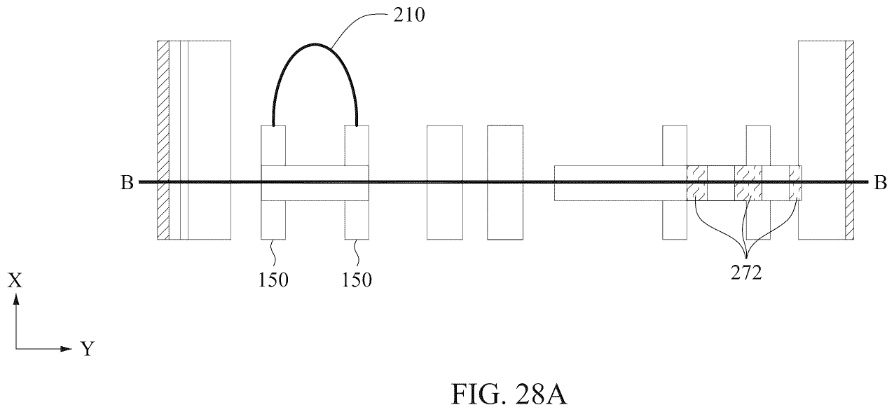

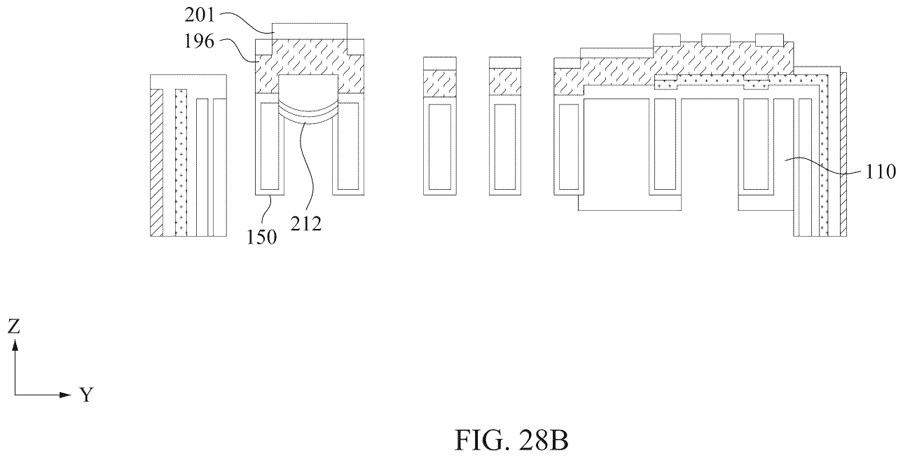

In some embodiments, the package as illustrated in FIG. 1 may be used as part of the MEMS actuator. In other embodiments, the bottom wafer 120 is subsequently removed or separated from the top wafer 110. This is indicated as optional step 356 of FIG. 5C, and the resulting structure is illustrated in FIG. 28A and FIG. 28B.

Any metal layer discussed herein may generally be formed from any conductive metal or conductive oxide. Examples of suitable metals may include copper, aluminum, nickel, chromium, gold, germanium, silver, titanium, tungsten, platinum, tantalum, ruthenium, cobalt, rhenium, palladium, or zirconium; composites like TiN, WN, or TaN; or alloys thereof like AlCu. Examples of suitable conductive oxides may include indium tin oxide (ITO), zinc oxide (ZnO), tin oxide (SnO), aluminum zinc oxide (AlZnO), indium oxide (InO), or cadmium oxide (CdO). The metal or oxide material may be deposited, for example, via evaporation or sputtering, plating, chemical vapor deposition (CVD), physical vapor deposition (PVD), atomic layer deposition (ALD), or other suitable methods.

The structures and methods of the present disclosure also refer to several different dielectric layers. Such dielectric layers can generally be made from any suitable dielectric material or combination thereof, although the characteristics of any particular layer may also be further defined. Examples of dielectric materials may include silicon dioxide (SiO₂), silicon nitride (Si₃N₄), silicon carbide (SiC), hafnium dioxide (HfO₂), zirconium dioxide (ZrO₂), aluminum oxide (Al₂O₃), silicon oxynitride (SiOₓN_{y}), hafnium oxynitride (HfOₓN_{y}) or zirconium oxynitride (ZrOₓN_{y}), or hafnium silicates (HfSiₓO_{y}) or zirconium silicates (ZrSiₓO_{y}) or silicon carboxynitride (SiCₓO_{y}N_{z}), or hexagonal boron nitride (hBN). Other dielectric materials may include tantalum oxide (Ta₂O₅), nitrides such as silicon nitride, polysilicon, phosphosilicate glass (PSG), fluorosilicate glass (FSG), undoped silicate glass (USG), high-stress undoped silicate glass (HSUSG), and borosilicate glass (BSG). The dielectric layer may be formed by any suitable means, including chemical vapor deposition (CVD), physical vapor deposition (PVD), atomic layer deposition (ALD), thermal oxidation, or other suitable methods.

It is also noted that certain conventional steps are not expressly described in the discussion above. For example, a pattern/structure may be formed in a given layer by applying a photoresist layer, patterning the photoresist layer, developing the photoresist layer, and then etching to transfer the pattern to the given layer.

Generally, a photoresist layer may be applied, for example, by spin coating, or by spraying, roller coating, dip coating, or extrusion coating. Typically, in spin coating, the substrate is placed on a rotating platen, which may include a vacuum chuck that holds the substrate in plate. The photoresist composition is then applied to the center of the substrate. The speed of the rotating platen is then increased to spread the photoresist evenly from the center of the substrate to the perimeter of the substrate. The rotating speed of the platen is then fixed, which can control the thickness of the final photoresist layer.

Next, the photoresist composition is baked or cured to remove the solvent and harden the photoresist layer. In some particular embodiments, the baking occurs at a temperature of about 90° C. to about 110° C. The baking can be performed using a hot plate or oven, or similar equipment. As a result, the photoresist layer is formed on the substrate.

The photoresist layer is then patterned via exposure to radiation. The radiation may be any light wavelength which carries a desired mask pattern. In particular embodiments, EUV light having a wavelength of about 13.5 nm is used for patterning, as this permits smaller feature sizes to be obtained. This results in some portions of the photoresist layer being exposed to radiation, and some portions of the photoresist not being exposed to radiation. This exposure causes some portions of the photoresist to become soluble in the developer and other portions of the photoresist to remain insoluble in the developer.

An additional photoresist bake step (post exposure bake, or PEB) may occur after the exposure to radiation. For example, this may help in releasing acid leaving groups (ALGs) or other molecules that are significant in chemical amplification photoresist.

The photoresist layer is then developed using a developer. The developer may be an aqueous solution or an organic solution. The soluble portions of the photoresist layer are dissolved and washed away during the development step, leaving behind a photoresist pattern. One example of a common developer is aqueous tetramethylammonium hydroxide (TMAH). Generally, any suitable developer may be used. Sometimes, a post develop bake or “hard bake” may be performed to stabilize the photoresist pattern after development, for optimum performance in subsequent steps.

Continuing, portions of the given layer below the patterned photoresist layer are now exposed. Etching transfers the photoresist pattern to the given layer below the patterned photoresist layer. After use, the patterned photoresist layer can be removed, for example, using various solvents such as N-methyl-pyrrolidone (NMP) or alkaline media or other strippers at elevated temperatures, or by dry etching using oxygen plasma.

Generally, any etching step described herein may be performed using wet etching, dry etching, or plasma etching processes such as reactive ion etching (RIE) or inductively coupled plasma (ICP), or combinations thereof, as appropriate. The etching may be anisotropic. Depending on the material, etchants may include carbon tetrafluoride (CF₄), hexafluoroethane (C₂F₆), octafluoropropane (C₃F₈), fluoroform (CHF₃), difluoromethane (CH₂F₂), fluoromethane (CH₃F), carbon fluorides, nitrogen (N₂), hydrogen (H₂), oxygen (O₂), argon (Ar), xenon (Xe), xenon difluoride (XeF₂), helium (He), carbon monoxide (CO), carbon dioxide (CO₂), fluorine (F₂), chlorine (Cl₂), hydrogen bromide (HBr), hydrofluoric acid (HF), nitrogen trifluoride (NF₃), sulfur hexafluoride (SF₆), boron trichloride (BCl₃), ammonia (NH₃), bromine (Br₂), or the like, or combinations thereof in various ratios. For example, silicon dioxide can be wet etched using hydrofluoric acid and ammonium fluoride. Alternatively, silicon dioxide can be dry etched using various mixtures of CHF₃, O₂, CF₄, and/or H₂.

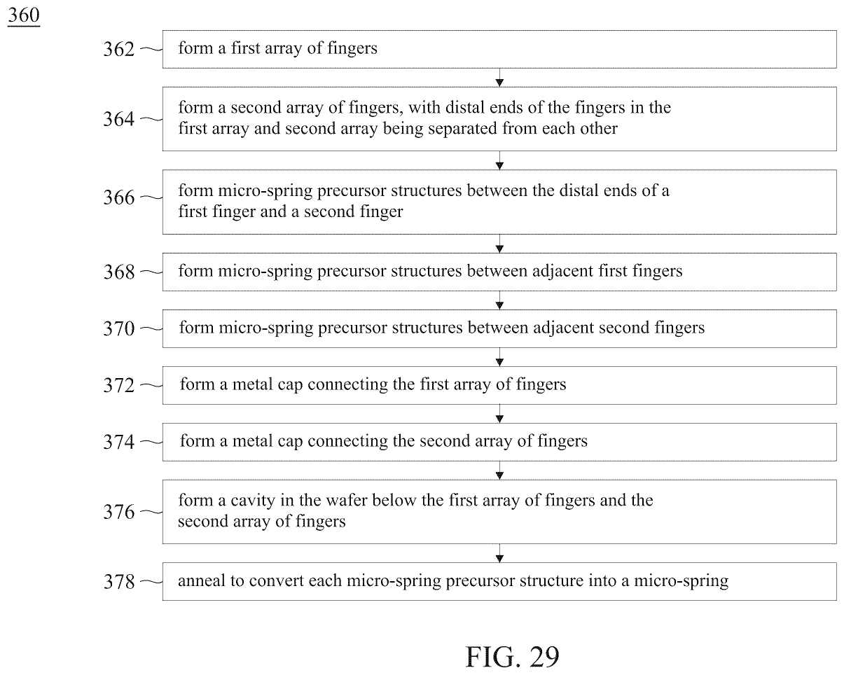

Continuing, FIG. 29 is a flow chart illustrating a more general method 360 for making an arm array that can be used, for example, in a MEMS actuator, in accordance with some embodiments.

In step 362 of FIG. 29, an array of first fingers 150 is formed from an electrically conductive material on a wafer 110. In step 364, an array of second fingers 170 is formed from an electrically conductive material on the wafer 110. The distal ends 160 of the array of first fingers and the distal ends 180 of the array of second fingers are offset from each other in one horizontal direction, and are separated from each other in the other horizontal direction. This structure is illustrated in FIGS. 7A-7C. The two arrays of fingers can be formed in one process step if they are made of the same material.

In step 366 of FIG. 29, micro-spring precursor structures 210 are formed between the distal ends 160, 180 of a first finger and a second finger. The micro-spring precursor structures 210 can also be described as being formed on pillars 222 located at the ends of two sets of trenches 230, 232. This structure is illustrated in FIG. 11A and FIG. 11C.

In step 368 of FIG. 29, micro-spring precursor structures 212 are formed between adjacent first fingers 150. The micro-spring precursor structures 212 can also be described as being formed on pillars 224 between two adjacent trenches 230. This structure is illustrated in FIG. 11B. In step 370 of FIG. 29, micro-spring precursor structures 212 are formed between adjacent second fingers.

In step 372 of FIG. 29, a metal cap 196 is formed that connects first fingers 150 together. This structure is illustrated in FIG. 24A and FIG. 24B. In step 374 of FIG. 29, a metal cap is formed that connects second fingers together.

In step 376 of FIG. 29, the wafer 110 is etched to form a cavity 112 below the first array of fingers and the second array of fingers. This structure is illustrated in FIG. 27A and FIG. 27B. It is noted that the micro-spring precursor structures 210, 212 are now exposed.

In step 378 of FIG. 29, annealing is performed to convert each micro-spring precursor structure into a micro-spring 202, 204. The resulting structure is illustrated in FIG. 1. The method 360 may also include any of the method steps mentioned in FIGS. 5A-5C.

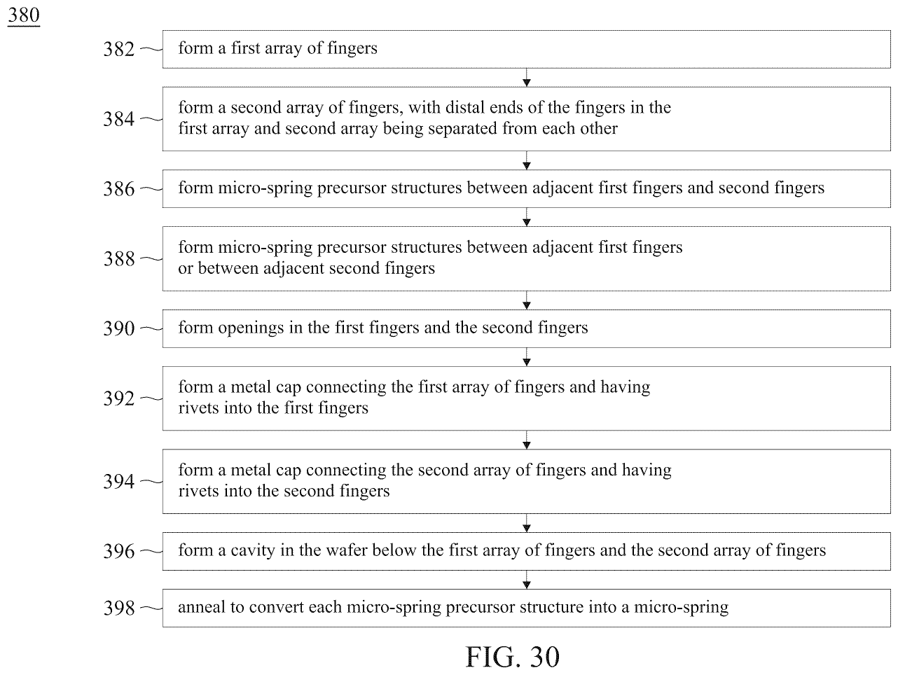

Continuing, FIG. 30 is a flow chart illustrating another general method 380 for making an arm array for a device like a MEMS actuator, in accordance with some embodiments. In this method, rivets 280 are present.

In step 382 of FIG. 30, an array of first fingers 150 is formed on a wafer 110. In step 384, an array of second fingers 170 is formed on the wafer 110. The distal ends 160 of the first array of fingers and the distal ends 180 of the second array of fingers may be separated from each other or interposed between each other. Such structures are illustrated in FIG. 4A and FIG. 4B.

In step 386 of FIG. 30, micro-spring precursor structures 212 are formed between adjacent first fingers 150 and second fingers 170. The micro-spring precursor structures 212 can also be described as being formed on pillars 224 between two sets of trenches 230, 232. In step 388 of FIG. 30, micro-spring precursor structures 212 are formed between adjacent first fingers or adjacent second fingers.

In step 390 of FIG. 30, openings 282 are formed in the first fingers and/or the second fingers. This is illustrated in FIG. 22A and FIG. 22B. In step 392, a metal cap 196 is formed that contacts first fingers 150 in the array of first fingers. Rivets are also formed that extend into the first fingers. In step 394, a metal cap 197 is formed that contacts second fingers 170 in the array of second fingers. Rivets are also formed that extend into the second fingers. This is schematically illustrated in FIG. 4B and FIG. 23B. It is contemplated that steps 392 and 394 could be combined into one step if the metal cap 196 contacts both first fingers 150 and second fingers 170, as illustrated in FIG. 4C.

In step 396, the wafer 110 is etched to form a cavity 112 below the first array of fingers and the second array of fingers. In step 398, annealing is performed to convert each micro-spring precursor structure into a micro-spring 202, 204. The resulting structure is illustrated in FIG. 1. The method 380 may also include any of the method steps mentioned in FIGS. 5A-5C.

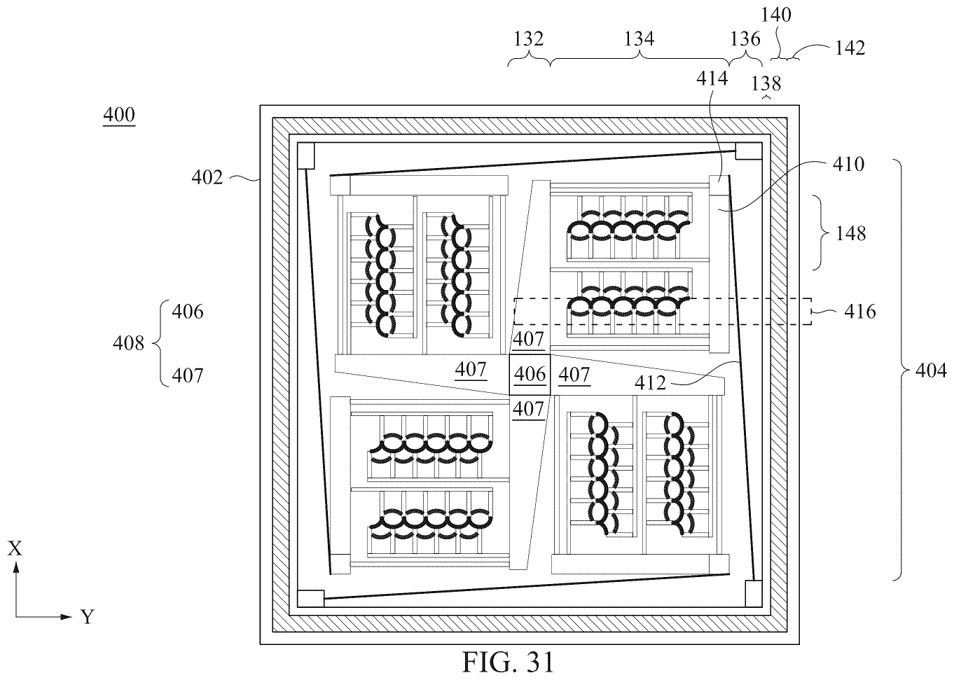

Continuing, FIG. 31 is a plan view of a MEMS actuator 400, in accordance with some embodiments. The illustrated actuator includes a four-sided frame 402 which surrounds and is spaced apart from a sensor connection component 404. The sensor connection component 404 includes an anchor 406 located at the center. As illustrated here, four anchor arms 407 extend from the anchor, and together they can be considered an anchor structure 408.

The sensor connection component can be described as having four quadrants, each quadrant being located between two anchor arms. Within each quadrant, an anchor arm supports 407 one or more micromechanical arm arrays 148 within a driving comb section 134 as previously described. As illustrated here, the driving comb section includes two micromechanical arm arrays, but any number of such arrays may be present. In particular embodiments, the driving comb section may contain from one to ten micromechanical arm arrays. The length of the driving comb section opposite the anchor arm 407 can serve as a support 410. A hinge 412 or cantilever traverses an open space to join the support 410 to a non-adjacent corner of the frame 402. Also located on each support is a sensor mount 414.

Box 416 generally indicates the location of the views of FIGS. 6-28B with respect to the entire actuator, and the process steps described above can be applied to the remainder of the MEMS actuator. The anchor arm section 132, driving comb section 134, hinge section 136, inner frame section 138, spring section 140, and outer frame section 142 of FIG. 1 are also indicated here. The anchor arm section 132 is part of the anchor arm 407. The inner frame section 138, spring section 140, and outer frame section 142 make up part of the frame 402 of the actuator. The overall dimensions of the MEMS actuator are usually in the millimeter range, for example below 20 mm×20 mm.

The MEMS actuator is useful for optical image stabilization (OIS). OIS is used to reduce blurring that can occur due to motion of an imaging device during exposure, such as binoculars, cameras (handheld, still, or video), telescopes, and cellphones/smartphones. The motion causes light which is initially detected in one pixel to move to an adjacent pixel, which shows up in the captured image as blurring. Blurring becomes more evident at higher resolution as the pixel size decreases. In the present disclosure, OIS is performed by moving the image sensor to compensate for changes in the optical path. This may be preferable to moving the lens because it reduces the weight and complexity of the lens(es), and the compensation can also be much quicker (on the order of a few milliseconds, rather than tens of milliseconds). The MEMS actuator can move in all five axes (i.e., X, Y, Roll, Yaw, and Pitch).

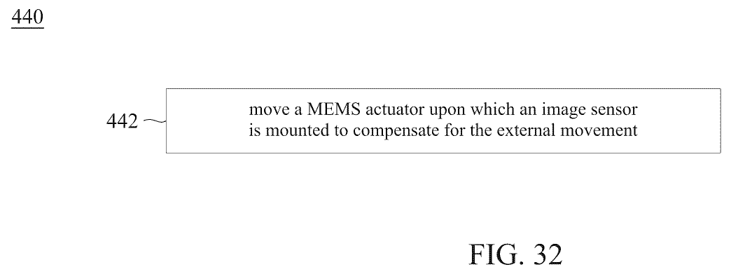

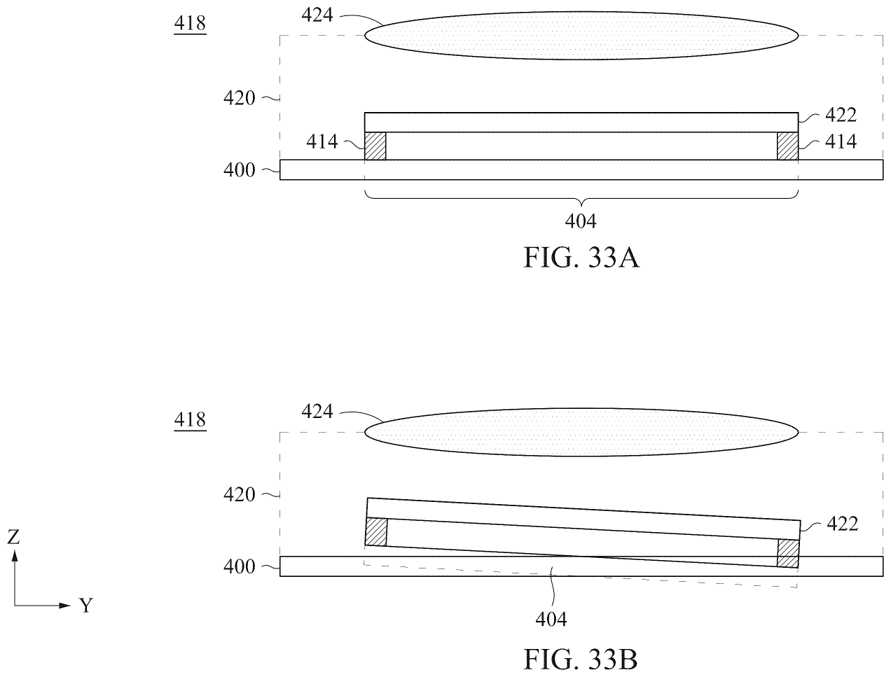

FIG. 32 is a flow chart illustrating a method 440 for stabilizing an optical image against external movement, in accordance with some embodiments. This method is performed using a MEMS actuator as shown in FIG. 31. Some steps of the method are also illustrated in FIG. 33A and FIG. 33B.

Initially, FIG. 33A is a side cross-sectional view of an optical image capture device 418. The device includes a MEMS actuator 400 as previously described, located within a housing 420. The sensor connection component 404 is labeled. Two sensor mounts 414 are also illustrated, and an image sensor 422 is mounted upon the MEMS actuator by attachment to the sensor mounts 414. The image sensor may be, for example, a charge-coupled device (CCD) or an active-pixel sensor (CMOS sensor). One or more lenses 424 is present within the housing. The image sensor is located between the lens and the MEMS actuator, so that light falls on the image sensor. Here, the image sensor 422 is in a first position, and an optical light path is present between the lens 424 and the image sensor 422.

When the device/housing is subjected to external movement, for example due to shaking in the hands of the user, in step 442 of FIG. 32, the MEMS actuator is moved to compensate for the external movement. This can be done, for example, by sending an electrical signal to the micromechanical arm array in one or more quadrants to change the physical distance between the array of first fingers and the array of second fingers. As illustrated in FIG. 33B, this causes the sensor connection component 404 of the actuator 400 to tilt relative to the frame, which moves the image sensor 422 to a second position, so that the optical light path still hits the same location on the image sensor.

The structures including an arm array with the longitudinal micro-springs is more stable and more difficult to break. Due to their relatively larger amplitude, they can endure more pressure/stress without breaking. In addition, because many of the fingers will have three or four micro-springs, even when for example 50% of the micro-springs are broken, the overall array will still maintain up to 90-99% efficacy, rather than losing 50% efficacy. This improves device lifetime and increases customer satisfaction.

Some embodiments of the present disclosure thus relate to various methods for making an arm array for a device, like a MEMS actuator. An array of first fingers and an array of second fingers are formed on a wafer. The array of first fingers and the array of second fingers are separated from each other by a lateral trench. For each finger in the array of first fingers, at least one longitudinal micro-spring precursor structure is formed with an adjacent finger in the array of second fingers. A cavity is then formed in the wafer below the array of first fingers and the array of second fingers. Annealing is performed to convert each longitudinal micro-spring precursor structure into a longitudinal micro-spring.

Also described in various embodiments herein are devices that comprise an anchor structure, such as for example a MEMS actuator. A plurality of arm arrays are connected to the anchor structure. Each arm array comprises an array of first fingers and an array of second fingers. The first array of spaced-apart fingers extends from a first arm in a longitudinal direction. The second array of spaced-apart fingers extends from a second arm in the longitudinal direction. The array of first fingers and the array of second fingers are separated from each other by a lateral trench. One or more longitudinal micro-springs connect each finger in the array of first fingers to adjacent fingers in the array of second fingers.

In further embodiments, each arm array further comprises: lateral micro-springs connecting adjacent fingers within the same array; or a metal cap above the array of first fingers or the array of second fingers.

Furthermore, the array of first fingers and the array of second fingers are located within a driving comb section. The arm array may further comprise an anchor arm section that connects to the anchor structure, a hinge section, an inner frame section, a spring section, and an outer frame section.

Also described in various embodiments herein are methods for stabilizing an optical image against external movement. This is done by moving a MEMS actuator upon which an image sensor is mounted to compensate for the external movement. The MEMS actuator comprises a plurality of micromechanical arm arrays connected to an anchor structure, with each arm array having components as described above.

The present disclosure also relates in various embodiments to optical image capture devices that comprise: an image sensor mounted to a MEMS actuator; and a lens located so that the image sensor is between the lens and the MEMS actuator. The MEMS actuator comprises a plurality of micromechanical arm arrays connected to an anchor structure. Each arm array comprises an array of first fingers and an array of second fingers. The first array of spaced-apart fingers extends from a first arm in a longitudinal direction. The second array of spaced-apart fingers extends from a second arm in the longitudinal direction. The array of first fingers and the array of second fingers are separated from each other by a lateral trench. One or more longitudinal micro-springs connect each finger in the array of first fingers to adjacent fingers in the array of second fingers.

Some embodiments of the present disclosure also relate to various methods for making an arm array, such as may be used in devices like a MEMS actuator. An array of first fingers and an array of second fingers are formed on a wafer. Openings are formed in the first fingers and/or the second fingers. Deposition and patterning of a metal layer results in a metal cap being formed upon the first fingers and/or the second fingers, with rivets extending into the openings. A cavity is then formed in the wafer below the first array of fingers and the second array of fingers. Optionally, micro-spring precursor structures are formed, and annealing is performed to convert each micro-spring precursor structure into a micro-spring.

Other embodiments disclosed herein relate to various methods for making an arm array, such as for a MEMS actuator. A package is received that comprises a top wafer bonded to a bottom wafer. The top wafer is patterned to form a first set of trenches, a second set of trenches, and at least one pillar. A dielectric layer is formed on exposed surfaces of the first set of trenches, the second set of trenches, and the at least one pillar. A metal layer is formed upon the at least one pillar to obtain at least one micro-spring precursor structure. Optionally, at least one sacrificial spacer is formed upon the at least one micro-spring precursor structure. A dielectric layer is then formed on exposed surfaces of the at least one micro-spring precursor structure and the at least one sacrificial spacer. An electrically conductive material is deposited into the first set of trenches to form an array of first fingers. An electrically conductive material is deposited into the second set of trenches to form an array of second fingers. Openings are formed in at least two fingers in the first array of fingers; A metal cap that fills the openings of the at least two fingers in the array of first fingers to form rivets. Etching is performed to remove the optional at least one sacrificial spacer and form a cavity within the top wafer. Annealing is performed to convert each micro-spring precursor structure into a micro-spring.

Also described in various embodiments herein are devices such as MEMS actuators that comprise an anchor structure. A plurality of arm arrays are connected to the anchor structure. Each arm array comprises an array of first fingers and an array of second fingers. The first array of spaced-apart fingers extends from a first arm in a longitudinal direction. The second array of spaced-apart fingers extends from a second arm in the longitudinal direction. The distal ends of the first fingers and the second fingers may be separated from each other by a lateral trench, or they may be interposed with each other. A metal cap extends over the array of first fingers. The metal cap includes rivets that extend into at least two of the first fingers.

In further embodiments, each arm array further comprises: micro-springs connecting each first finger to adjacent second fingers; and/or micro-springs connecting each first finger to adjacent first fingers.

Furthermore, the first array of fingers and the second array of fingers are located within a driving comb section. The arm array may further comprise an anchor arm section that connects to the anchor structure, a hinge section, an inner frame section, a spring section, and an outer frame section.

Also described in various embodiments herein are methods for stabilizing an optical image against external movement. This is done by moving a MEMS actuator upon which an image sensor is mounted to compensate for the external movement. The MEMS actuator comprises a plurality of micromechanical arm arrays connected to an anchor structure, with each arm array having a metal cap with rivets as described above.

Finally, the present disclosure also relates in various embodiments to optical image capture devices that comprise: an image sensor mounted to a MEMS actuator; and a lens located so that the image sensor is between the lens and the MEMS actuator. The MEMS actuator comprises a plurality of micromechanical arm arrays connected to an anchor structure. Each arm array comprises an array of first fingers and an array of second fingers. The first array of spaced-apart fingers extends from a first arm in a longitudinal direction. The second array of spaced-apart fingers extends from a second arm in the longitudinal direction. The distal ends of the first fingers and the second fingers may be separated from each other by a lateral trench, or they may be interposed with each other. A metal cap extends over the array of first fingers. The metal cap includes rivets that extend into at least two of the first fingers.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for making an arm array, comprising:
forming an array of first fingers and an array of second fingers on a wafer, wherein the array of first fingers and the array of second fingers are separated from each other by a lateral trench;
for each finger in the array of first fingers, forming at least one longitudinal micro-spring precursor structure with an adjacent finger in the array of second fingers;
forming a cavity in the wafer below the array of first fingers and the array of second fingers; and
annealing to convert each longitudinal micro-spring precursor structure into a longitudinal micro-spring.

2. The method of claim 1, further comprising forming a metal cap that contacts each finger in the array of first fingers.

3. The method of claim 2, wherein the metal cap includes rivets into each finger in the array of first fingers.

4. The method of claim 2, wherein the metal cap comprises aluminum or an aluminum alloy.

5. The method of claim 1, wherein the array of first fingers and the array of second fingers are formed from polysilicon or a piezoelectric material.

6. The method of claim 1, wherein each finger in the array of first fingers and the array of second fingers is covered with a cover layer.

7. The method of claim 1, wherein each longitudinal micro-spring precursor structure comprises a metal layer and a dielectric layer bonded to each other.

8. The method of claim 1, wherein the at least one longitudinal micro-spring precursor structure is formed by:
patterning the wafer to form a pillar within the lateral trench that extends from the finger in the array of first fingers to a distal end of the adjacent finger in the array of second fingers;
forming a dielectric layer on the pillar; and
forming a metal layer upon the pillar to obtain the at least one longitudinal micro-spring precursor structure.

9. The method of claim 8, wherein the pillar is removed when the cavity in the wafer is formed.

10. The method of claim 1, further comprising:
for each finger in the array of first fingers, forming at least one lateral micro-spring precursor structure with an adjacent finger in the array of first fingers.

11. The method of claim 10, wherein the at least one longitudinal micro-spring precursor structure and the at least one lateral micro-spring precursor structure are at different levels.

12. A device, comprising:
an anchor structure; and
a plurality of arm arrays connected to the anchor structure, each arm array comprising:
a first array of spaced-apart fingers extending from a first arm in a longitudinal direction;
a second array of spaced-apart fingers extending from a second arm in the longitudinal direction, wherein the array of first fingers and the array of second fingers are separated from each other by a lateral trench; and
one or more longitudinal micro-springs connecting each finger in the array of first fingers to adjacent fingers in the array of second fingers.

13. The device of claim 12, wherein each arm array further comprises:
lateral micro-springs connecting each finger in the array of first fingers to adjacent fingers in the array of second fingers; and
a metal cap above at least two fingers in the array of first fingers.

14. The device of claim 12, wherein the array of first fingers and the array of second fingers are located within a driving comb section, and the arm array further comprises an anchor arm section connected to the anchor structure, a hinge section, an inner frame section, a spring section, and an outer frame section.

15. A method for making an arm array, comprising:
receiving a package that comprises a top wafer bonded to a bottom wafer;
patterning the top wafer to form a first set of trenches, a second set of trenches, and at least one pillar;
forming a dielectric layer on exposed surfaces of the first set of trenches, the second set of trenches, and the at least one pillar;
forming a metal layer upon the at least one pillar to obtain at least one micro-spring precursor structure;
optionally forming at least one sacrificial spacer upon the at least one micro-spring precursor structure and forming a dielectric layer on exposed surfaces of the at least one micro-spring precursor structure and the at least one sacrificial spacer;
depositing an electrically conductive material into the first set of trenches to form an array of first fingers;
depositing an electrically conductive material into the second set of trenches to form an array of second fingers;
forming openings in at least two fingers in the array of first fingers;
forming a metal cap that fills the openings of the at least two fingers in the array of first fingers to form rivets;
etching to remove the optional at least one sacrificial spacer and form a cavity within the top wafer; and
annealing to convert each micro-spring precursor structure into a micro-spring.

16. The method of claim 15, wherein distal ends of the array of first fingers and distal ends of the array of second fingers are interposed between each other.

17. The method of claim 15, wherein proximal ends of the array of first fingers extend in a first direction and are joined to a first arm, and proximal ends of the array of second fingers extend in a second direction opposite the first direction and are joined to a second arm.

18. The method of claim 15, wherein distal ends of the array of first fingers and distal ends of the array of second fingers are interposed between each other.

19. The method of claim 15, wherein the at least one pillar extends from a trench in the first set of trenches to a trench in the second set of trenches.

20. The method of claim 15, further comprising forming a passivation layer over the metal cap.
